(19) United States
(12) Patent Application Publication
(10) Pub. No.: US 2022/0343422 A1
(43) Pub. Date: Oct. 27, 2022

(54) PREDICTING OCCURRENCES OF FUTURE EVENTS USING TRAINED ARTIFICIAL-INTELLIGENCE PROCESSES AND NORMALIZED FEATURE DATA

(71) Applicant: The Toronto-Dominion Bank, Toronto (CA)

(72) Inventors: Saba ZUBERI, Toronto (CA); Shrinu KUSHAGRA, Toronto (CA); Callum Iain MAIR, Toronto (CA); Steven Robert ROMBOUGH, Toronto (CA); Farnush FARHADI HASSAN KIADEH, Toronto (CA); Maksims VOLKOVS, Toronto (CA); Tomi Johan POUTANEN, Toronto (CA)

(21) Appl. No.: 17/726,184

(22) Filed: Apr. 21, 2022

Related U.S. Application Data
(60) Provisional application No. 63/177,810, filed on Apr. 21, 2021.

(51) Int. Cl. G06Q 40/02; G06N 20/20

(52) U.S. Cl. CPC G06Q 40/025; G06N 20/20

(57) ABSTRACT

In some examples, computer-implemented systems and processes facilitate a prediction of occurrences of future events using trained artificial intelligence processes and normalized feature data. For instance, an apparatus may generate an input dataset based on elements of interaction data that characterize an occurrence of a first event during a first temporal interval, and that include at least one element of normalized data. Based on an application of a trained artificial intelligence process to the input dataset, the apparatus may generate output data representative of a predicted likelihood of an occurrence of a second event associated with during a second temporal interval. The apparatus may also transmit at least a portion of the output data to a computing system, which may perform operations consistent with the portion of the output data.

### CROSS-REFERENCE TO RELATED APPLICATION

This application claims the benefit of priority under 35 U.S.C. § 119(e) to prior U.S. Provisional Application No. 63/177,810, filed Apr. 21, 2021, the disclosure of which is incorporated by reference herein to its entirety.

### TECHNICAL FIELD

The disclosed exemplary embodiments generally relate to computer-implemented systems and processes that facilitate a prediction of occurrences of future events using trained artificial intelligence processes and normalized feature data.

### BACKGROUND

Today, many financial institutions extend credit in the form of credit-card accounts, personal loans, and other unsecured lines-of-credit to their customers in accordance with certain terms and conditions, such as a repayment schedule or corresponding interest rate. The terms and conditions associated with the extended credit may be established initially by the financial institutions prior to issuing the credit-card accounts, personal loans, and unsecured lines-of-credit to corresponding ones of the customers and further, the financial institutions may elect to modify one or more of the terms and conditions of the extended credit based on an evolution in the relationships between the financial institutions and the customers, and based on the customer's use, or misuse, of various financial or credit instruments issued by these financial institutions.

### SUMMARY

In some examples, an apparatus includes a memory storing instructions, a communications interface, and at least one processor coupled to the memory and the communications interface. The at least one processor is configured to execute the instructions to generate an input dataset based on elements of first interaction data. The elements of first interaction data characterize an occurrence of a first event during a first temporal interval, and the input dataset includes at least one element of normalized data. The at least one processor is further configured to execute the instructions to, based on an application of a trained artificial intelligence process to the input dataset, generate output data representative of a predicted likelihood of an occurrence of a second event during a second temporal interval. The second event is associated with the first event, and the second temporal interval is subsequent to the first temporal interval and is separated from the first temporal interval by a corresponding buffer interval. The at least one processor is configured to execute the instructions to transmit at least a portion of the output data to a computing system via the communications interface. The computing system is configured to perform operations consistent with the portion of the output data.

In other examples, a computer-implemented method, includes generating, using at least one processor, an input dataset based on elements of first interaction data. The elements of first interaction data characterize an occurrence of a first event during a first temporal interval, and the input dataset includes at least one element of normalized data. The computer-implemented method includes, based on an application of a trained artificial intelligence process to the input dataset, generating, using the at least one processor, output data representative of a predicted likelihood of an occurrence of a second event during a second temporal interval. The second event is associated with the first event, and the second temporal interval is subsequent to the first temporal interval and is separated from the first temporal interval by a corresponding buffer interval. The computer-implemented method includes transmitting at least a portion of the output data to a computing system using the at least one processor. The computing system is configured to perform operations consistent with the portion of the output data.

Further, in some examples, a tangible, non-transitory computer-readable medium stores instructions that, when executed by at least one processor, cause the at least one processor to perform a method that includes generating an input dataset based on elements of first interaction data. The elements of first interaction data characterize an occurrence of a first event during a first temporal interval, and the input dataset includes at least one element of normalized data. The method includes, based on an application of a trained artificial intelligence process to the input dataset, generating output data representative of a predicted likelihood of an occurrence of a second event during a second temporal interval. The second event is associated with the first event, and the second temporal interval is subsequent to the first temporal interval and is separated from the first temporal interval by a corresponding buffer interval. The method includes transmitting at least a portion of the output data to a computing system. The computing system is configured to perform operations consistent with the portion of the output data.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed exemplary embodiments, as set forth in the accompanying claims.

### BRIEF DESCRIPTION OF THE DRAWINGS

FIGS. 1A, 1B, and 1C are block diagrams illustrating portions of an exemplary computing environment, in accordance with some exemplary embodiments;

FIGS. 1D and 1E are diagrams of exemplary timelines for adaptively training a machine-learning or artificial intelligence process, in accordance with some exemplary embodiments;

FIGS. 2A and 2B are block diagrams illustrating additional portions of the exemplary computing environment, in accordance with some exemplary embodiments;

FIG. 3 is a flowchart of an exemplary process for adaptively training a machine learning or artificial intelligence process, in accordance with some exemplary embodiments;

FIG. 4 is a flowchart of an exemplary process for predicting likelihoods of future occurrences of default events based on an application of trained machine-learning or artificial-intelligence processes to customer-specific input datasets, in accordance with some exemplary embodiments; and

Like reference numbers and designations in the various drawings indicate like elements.

### DETAILED DESCRIPTION

Modern financial institutions offer a variety of financial products or services to their customers, both through in-person branch banking and through various digital channel, and decisions related to the provisioning of a particular financial product or service to a customer are often informed by the customer's relationship with the financial institution and the customer's use, or misuse, of other financial products or services. For example, one or more computing systems of a financial institution may obtain, generate, and maintain elements of customer profile data identifying a customer of the financial institution and characterizing the customer's relationship with the financial institution, elements of account data identifying and characterizing one or more financial products issued to the customer by the financial institution, elements of transaction data identifying and characterizing one or more transactions involving these issued financial products, or elements of reporting data, such as credit-bureau data associated with the particular customer. The elements of customer profile data, account data, transaction data, and/or reporting data may establish collectively a time-evolving risk profile for the customer, and the financial institution may base not only a decision to provision the particular financial product or service to the corresponding customer, but also a determination of one or more terms and conditions of the provisioned financial product or service, on the established risk profile.

In some instances, the customer may represent a business customer of the financial institution, such as, but not limited to, an owner of a small business associated with, and operating within, one or more types or classes of industries (e.g., the agriculture, healthcare, forestry, restaurant, transportation, or hospitality industries, etc.), and additionally, or alternatively, one or more subdivisions of these types or classes of industries (e.g., subdivisions of the restaurant industry associated with fast-food, fast-casual, fine-dining, or catering establishments, etc.). Further, in some instances, the financial products or services provisioned to the business customer may include, but are not limited to, one or more credit products, which the business customer may rely upon to support inventory purchases and employee salaries through temporal fluctuations in business activity (e.g., due to factors such as seasonality, weather, or market conditions, etc.).

Examples of these credit products include, but are not limited to, a credit-card account, a secured or unsecured line-of-credit, and/or an overdraft protection (ODP) product, and the initial terms and conditions imposed on the credit product may include, but are not limited to, an amount of credit extended to the business customer, a repayment schedule, an interest rate, or a penalty imposed upon the business customer by the financial institution in response to a determined violation of the initial terms or conditions. For instance, and for an unsecured line-of-credit issued to the business customer, the terms and conditions may include a repayment schedule specifying that a minimum monthly payment for the unsecured line-of-credit (e.g., a sum of any accrued interest and a portion of a principal balance, etc.) is due at the financial institution on or before the eleventh day of each month, a variable annual percentage rate (APR), and a specified increase in the variable APR in response to the determined violation of the initial terms or conditions.

In some instances, one or more of the business customers of the financial institution that hold the credit products may submit regular, monthly payments to the financial institution in accordance with the corresponding repayment schedule, and upon completion of the repayment schedule, the financial institution may deem corresponding ones of the credit products repaid in-full (e.g., including any utilized portion of the extended credit and any accrued interest). In other instances, described herein, one or more of the business customers of the financial institution that hold the credit products, such as the small-business owner, may fail to submit a required monthly payment to the financial institution in accordance with the corresponding repayment schedule (e.g., on or before a corresponding due date), and based on the failure to submit the required monthly payment, the financial institution may deem each of these credit products delinquent (e.g., “past due”) as of the corresponding due date of the required monthly payment. The failure to submit the required monthly payment associated with one or more of the credit products by the corresponding due date may, for example, represent an occurrence of a “delinquency event” involving a corresponding one of the products and a corresponding one of the business customers of the financial institution, and each of the delinquency events may remain pending until resolution by the corresponding one of the business customers of the financial institution or by the financial institution. Examples of potential resolutions to these delinquency events may include, among other things, a repayment of a past-due balance by a corresponding one of the business customers, by a settlement negotiated between the financial institution and a corresponding one of the business customers, a bankruptcy filing by the corresponding one of the business customers, or a write-off of a past-due balance by the financial institution.

The failure of these business customers to submit the required monthly payment may, for example, result from carelessness or a lapse of memory on the part of the business customers, or may be indicative of financial distress on the part of the business customers. Furthermore, the underlying causes of the occurrences of these delinquency events may be indicative of a speed and an ease at which these delinquency events are resolved by the corresponding ones of the business customers and the financial institution, either individually or through collection action. For example, for a missed payment resulting from a mere lapse of memory on the part of a corresponding business customer, or due a seasonal fluctuation in business activity experienced by similar business customers (e.g., owners of small businesses associated with a corresponding industry type or class), the associated delinquency event may be resolved rapidly and without significant intervention by the financial institution. Alternatively, if the delinquency event were triggered by the financial distress of the business customer, or based on fluctuations in the business activity of the business customer that deviate from the fluctuations in business activity experienced by the similar business customers, an early and significant intervention by the financial institution (e.g., through the application of one or more remediation processes or treatments) may be necessary to resolve the delinquency event or to reduce an exposure of the financial institution to losses resulting from the delinquency event.

To mitigate an exposure of the financial institution to losses from pending delinquency events involving the credit products issued to the business customers, one or more computing systems of the financial institution may perform operations that characterize a credit exposure or a credit risk associated with each of the pending delinquency events, determine an expected timeline for resolving each of the pending delinquency events, and identify one or more of the remediation processes or treatments that, when applied to corresponding ones of the pending delinquency events, resolve the pending delinquency event or reduce a potential financial impact of the pending delinquency event on the financial institution. The determination of the expected timeline for resolving each of the pending delinquency events often depends on the underlying, customer-specific events that trigger the pending delinquency events, such as memory lapse or financial distress, and in some instances, the one or more computing systems of

Attorney Docket No.: G4144-00532 the financial institution may implement one or more rules-based or adaptive processes for determine the expected timeline for resolving each of the pending delinquency events, and to identify corresponding ones of the remediation processes or treatments.

In some examples, many of the existing rules-based processes implemented by the computing systems of the financial institution to characterize the expected resolution time and identify the appropriate remediation process or treatment rely on coarse, global metrics of the business customer's behavior, such as the credit-bureau scores of the business customers, and not on inferences that reflect the utilization of one or more accounts by the business customers (including temporal flows of cash into, and out of, these accounts), prior resolved or unresolved delinquency events involving the business customers, and comparisons between the activities of the delinquent business customers and those of similar business customers of the financial institution (e.g., owners of small business operating within common types of industries, etc.) during a current or prior temporal interval. Additionally, these rules-based processes are often implemented upon detection of an occurrence of corresponding delinquency event, and may be incapable of analyzing, or accounting for, changes in a behavior of the business customers during the pendency of the delinquency event.

Further, many existing adaptive processes for discerning the underlying, customer-specific events that trigger the pending delinquency events, and for predicting the expected resolution time for the pending delinquency events, may be specific to certain credit products, or types of credit products, and may require iterative application to corresponding sets of input data characterizing one or more delinquency events involving the specific credit products, or specific types of credit products. The computational time required to adaptively train and deploy these adaptive processes (e.g., machine-learning processes, artificial-intelligence processes, stochastic statistical processes, etc.) for a single credit product, or a single type of credit product, when repeated across the variety of credit products and types of credit products available at the financial institution, may render impractical any real-time discernment of the underlying, customer-specific events that trigger the pending delinquency events or any prediction of the expected resolution time for these pending delinquency events. Further, as these adaptive techniques are often trained against elements of training data that characterize an initial occurrence of a delinquency event, these existing adaptive techniques may be inappropriate for deployment against input datasets characterizing changes in the behavior of the business customers during the pendency of the delinquency event and subsequent to the initial occurrence.

In some examples, described herein, a machine-learning or artificial-intelligence process may be trained adaptively to predict, at a temporal prediction point, a likelihood of an occurrence of default event involving a business customer of a financial institution and a credit product issued by that financial institution during a predetermined, future temporal interval. As described herein, the business customer may be associated with a delinquency event involving the credit product, and at the temporal prediction point, the delinquency event may be characterized by a pendency period that fails to exceed a first threshold duration, such as, but not limited to, thirty calendar days. Further, as described herein, the default event involving the business customer and the credit product may occur during the future temporal interval when the delinquency event remains pendant for a period that is equivalent to, or that exceeds, a second threshold duration, such as, but not limited to, sixty calendar days.

As described herein, the machine-learning or artificial-intelligence process may include an ensemble or decision-tree process, such as a gradient-boosted decision-tree process (e.g., XGBoost model), and certain of the exemplary training and validation processes described herein may generate, and utilize, training datasets associated with a first prior temporal interval (e.g., a “training” interval), and using validation datasets associated with a second, and distinct, prior temporal interval (e.g., an out-of-time “validation” interval). In some examples, the training and validation data may include elements of data, e.g., feature values, characterizing customers, such as business customers, of the financial institution associated with delinquency events involving not a single credit product or single type of credit product, by a plurality of different credit products issued to the business customers of the financial institution.

Through the implementation of the exemplary processes described herein, one or more computing systems of the financial institution (e.g., which may collectively establish a distributed computing cluster associated with the financial institution) may perform operations that adaptively, and concurrently, train the machine-learning or artificial-intelligence process (e.g., the trained gradient-boosted, decision-tree process described herein) to predict the likelihood of the occurrences of the default event across the plurality of credit products based on the corresponding subsets of the training and validation data. Further, the trained machine-learning or artificial-intelligence process (e.g., the trained gradient-boosted, decision-tree process described herein) may further ingest input datasets associated with one or more business customers of the financial institution that are associated with a corresponding, pending delinquency event involving a corresponding credit product issued by the financial institution. Based on an application of the trained machine-learning or artificial-intelligence process to the input datasets, the one or more Fl computing systems may generate, at any point during the pendency of the delinquency event, and in accordance with a predetermined temporal schedule (e.g., at or before a predetermined time or date on a monthly basis), elements of output data (e.g., numerical values ranging from zero to unity) indicative of a likelihood of an occurrence of a default event involving the corresponding business customer and the corresponding credit product within a predetermined time period subsequent to an occurrence of the corresponding delinquency event.

Certain of these exemplary processes, which adaptively train and validate a machine-learning or artificial-intelligence process using customer- and industry-specific training and validation datasets associated with respective training and validation periods, and which apply the trained and validated machine-learning or artificial-intelligence process to additional customer-specific input datasets, may enable the one or more computing systems of the financial institution to predict, at any time during the pendency of a delinquency event involving a business customer and a credit product, a likelihood of an occurrence of a default event involving the business customer and the credit product within a predetermined time period subsequent to an occurrence of the delinquency event (e.g., via an implementation of one or more parallelized, fault-tolerant distributed computing and analytical protocols across clusters of graphical processing units (GPUs) and/or tensor processing units (TPUs)). These exemplary processes may, for example, be implemented in addition to, or as alternative to, existing processes through which the one or more computing systems implement rules-based processes that analyze the coarse metrics of customer behavior, of through which the one or more computing systems train multiple, product-specific adaptive processes trained against data characterizing an initial occurrence of the delinquency event. Further, one or more of the exemplary processes described herein provide, to the financial institution, a real-time indication of the likelihood of an occurrence of a default event subsequent to a delinquency event involving one or more business customers, which may inform a determination and application of one or more remediation processes or treatments the mitigate the potential occurrence of the default event or resolve the delinquency event.

Furthermore, and based on the application of the trained and validated gradient-boosted, decision-tree processes to input datasets characterizing business customers of the financial institution associated with corresponding delinquency events, certain of these exemplary processes may enable the one or more computing systems of the financial institution to generate, in real-time, elements of output data characterizing a predicted likelihood of an occurrence of a default event involving respective ones of the business customers within a predetermined time period subsequent to an occurrence of the corresponding delinquency event (e.g., via the implementation of one or more of the parallelized, fault-tolerant distributed computing and analytical protocols described herein across clusters of graphical processing units (GPUs) and/or tensor processing units (TPUs)). These exemplary processes may, for example, be implemented by the one or more computing systems of the financial institution in addition to, or as an alternative to, other predictive processes that rely on data consolidation, pre-processing, and aggregation processes capable of generating the customer-specific input datasets, or generating the elements of predicted output, at coarser temporal frequencies, such as, but not limited to, on a weekly basis, on a monthly basis, or on a quarterly basis.

### A. Exemplary Processes for Adaptively Training Gradient-Boosted, Decision Tree Processes in a Distributed Computing Environment

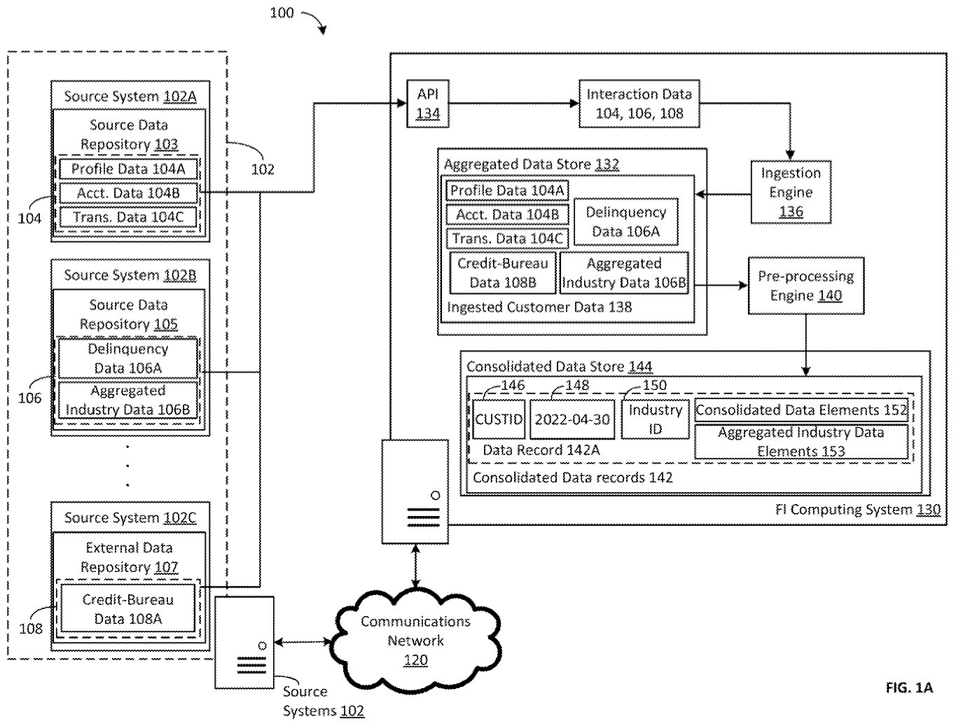

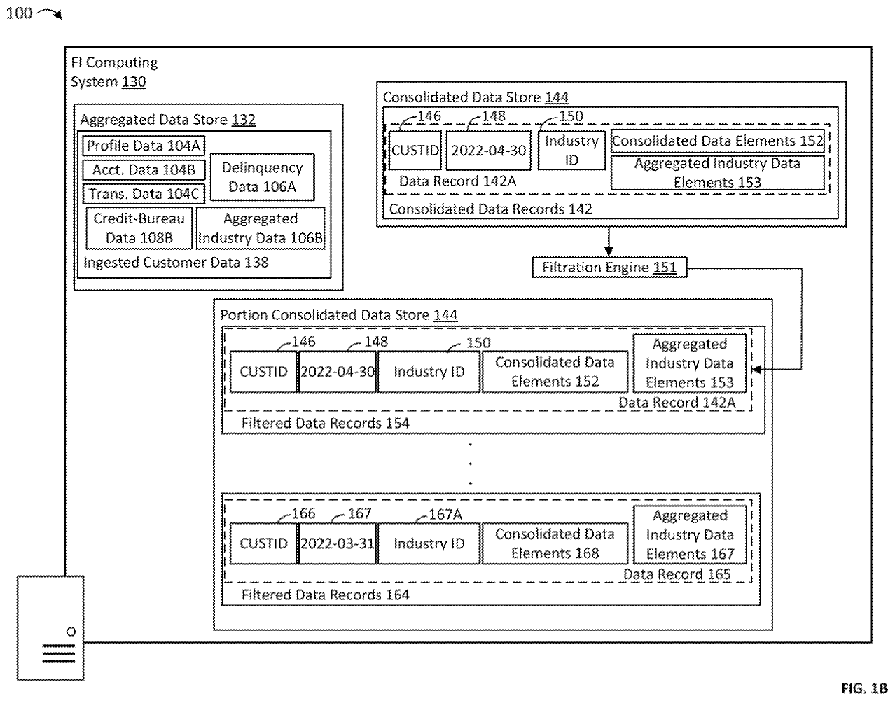

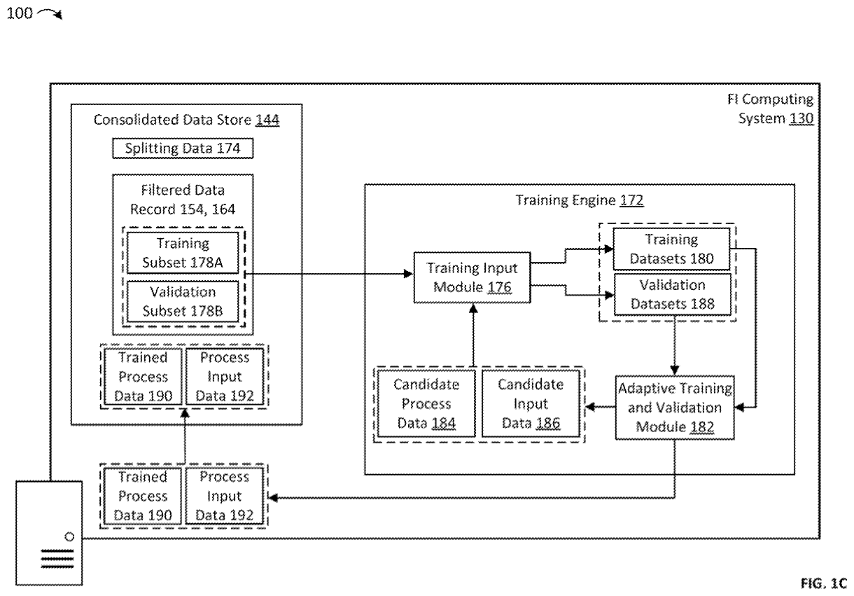

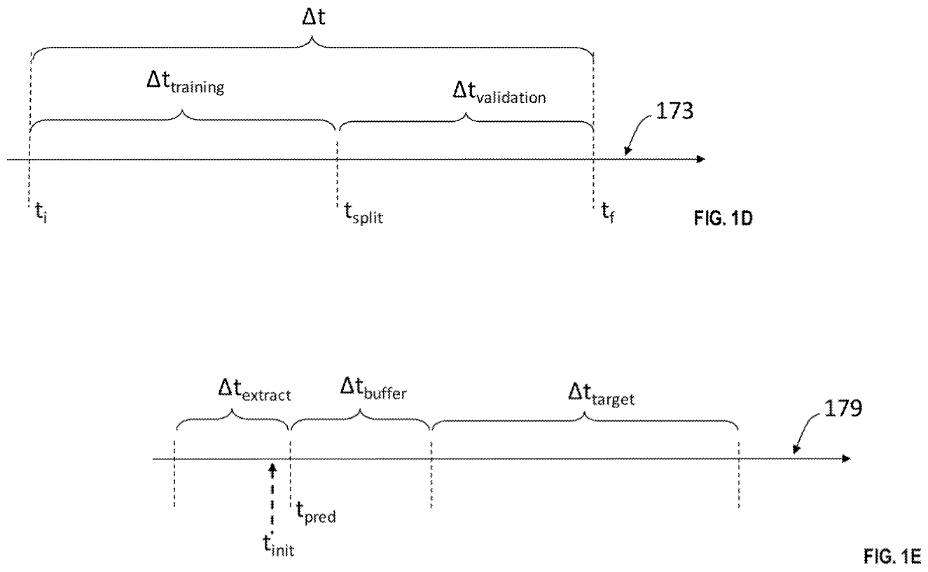

FIGS. 1A, 1B, and 1C illustrate components of an exemplary computing environment 100, in accordance with some exemplary embodiments. For example, as illustrated in FIG. 1A, environment 100 may include one or more source systems 102, such as, but not limited to, source systems 102A, 102B, and 102C, and one or more computing systems associated with, or operated by, a financial institution, such as a financial institution (FI) computing system 130. In some instances, each of source systems 102 (including source systems 102A, 102B, and 102C) and Fl computing system 130 may be interconnected through one or more communications networks, such as communications network 120. Examples of communications network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

In some examples, each of source systems 102 (including source systems 102A, 1028, and 102C) and Fl computing system 130 may represent a computing system that includes one or more servers and tangible, non-transitory memories storing executable code and application modules. Further, the one or more servers may each include one or more processors, which may be configured to execute portions of the stored code or application modules to perform operations consistent with the disclosed embodiments. For example, the one or more processors may include a central processing unit (CPU) capable of processing a single operation (e.g., a scalar operation) in a single clock cycle. Further, each of source systems 102 (including source systems 102A, 102B, and 102C) and Fl computing system 130 may also include a communications interface, such as one or more wireless transceivers, coupled to the one or more processors for accommodating wired or wireless internet communication with other computing systems and devices operating within environment 100.

Further, in some instances, source systems 102 (including source system 102A, source system 102B, and source system 102C) and Fl computing system 130 may each be incorporated into a respective, discrete computing system. In additional, or alternate, instances, one or more of source systems 102 (including source systems 102A, 102B, and 102C) and Fl computing system 130 may correspond to a distributed computing system having a plurality of interconnected, computing components distributed across an appropriate computing network, such as communications network 120 of FIG. 1A. For example, Fl computing system 130 may correspond to a distributed or cloud-based computing cluster associated with, and maintained by, the financial institution, although in other examples, Fl computing system 130 may correspond to a publicly accessible, distributed or cloud-based computing cluster, such as a computing cluster maintained by Microsoft Azure™, Amazon Web Services™, Google Cloud™, or another third-party provider.

In some instances, Fl computing system 130 may include a plurality of interconnected, distributed computing components, such as those described herein (not illustrated in FIG. 1A), which may be configured to implement one or more parallelized, fault-tolerant distributed computing and analytical processes (e.g., an Apache Spark™distributed, cluster-computing framework, a Databricks™ analytical platform, etc.). Further, and in addition to the CPUs described herein, the distributed computing components of Fl computing system 130 may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle. Through an implementation of the parallelized, fault-tolerant distributed computing and analytical protocols described herein, the distributed computing components of Fl computing system 130 may perform any of the exemplary processes described herein, in accordance with a predetermined temporal schedule, to ingest elements of data associated with the business customers of the financial institution, to preprocess the ingested data elements by filtering, aggregating, up- or down-sampling, and/or consolidating certain portions of the ingested data elements, and to store the preprocessed data elements within an accessible data repository (e.g., within a portion of a distributed file system, such as a Hadoop distributed file system (HDFS)).

Further, and through an implementation of the parallelized, fault-tolerant distributed computing and analytical protocols described herein, the distributed components of Fl computing system 130 may perform operations in parallel that not only train adaptively a machine learning or artificial intelligence process (e.g., the gradient-boosted, decision-tree process described herein) using corresponding training and validation datasets extracted from temporally distinct subsets of the preprocessed data elements, but also apply the trained machine learning or artificial intelligence process to customer-specific input datasets and generate, for corresponding ones of the business customers associated with a delinquency event that involves a credit product, elements of output data indicative of a predicted likelihood of an occurrence of default event involving the business customer and the credit product during a predetermined, future temporal interval. As described herein, the delinquency event involving the corresponding one of business customers and the credit product may be characterized by a pendency period of less than a first threshold pendency period, such as, but not limited to, thirty days.

Further, the default event involving the corresponding one of the business customers and the credit product may occur when the corresponding delinquency event remains pendant without resolution for at least a second threshold pendency period, such as, but not limited to, sixty calendar days, and the predetermined, future temporal interval may include an eight-month period disposed within one and nine months of a corresponding prediction date. The implementation of the parallelized, fault-tolerant distributed computing and analytical protocols described herein across the one or more GPUs or TPUs included within the distributed components of Fl computing system 130 may, in some instances, accelerate the training, and the post-training deployment, of the machine-learning and artificial-intelligence process when compared to a training and deployment of the machine-learning and artificial-intelligence process across comparable clusters of CPUs capable of processing a single operation per clock cycle.

Referring back to FIG. 1A, each of source systems 102 may maintain, within corresponding tangible, non-transitory memories, a data repository that includes confidential data associated with business customers of the financial institution that hold credit products issued by the financial institution. For example, source system 102A may be associated with, or operated by, the financial institution, and may maintain, within the corresponding one or more tangible, non-transitory memories, a source data repository 103 that includes one or more elements of interaction data 104.

In some instances, interaction data 104 may include data that identifies or characterizes one or more business customers of the financial institution and interactions between these business customers and the financial institution, and examples of the confidential data include, but are not limited to, customer profile data 104A, account data 104B, and transaction data 104C. In some instances, customer profile data 104A may include a plurality of data records associated with, and characterizing, corresponding ones of the business customers of the financial institution. By way of example, and for a particular business customer of the financial institution, the data records of customer profile data 104A may include, but are not limited to, one or more unique customer identifiers (e.g., an alphanumeric character string, such as a login credential, a customer name, etc.), location data (e.g., a street address of the business customer, etc.), other elements of contact data (e.g., a phone number, an email address, etc.), and other data characterizing the relationship between the particular business customer and the financial institution.

As described herein, the particular business customer may be associated with, and operate within, a corresponding industry type or class, and additionally, or alternatively, a corresponding subdivision of the industry type or class, and in some instances, the data records of customer profile data 104A may also include, for the particular business customer, a unique identifier of the corresponding industry type or class and/or the corresponding subdivision, such as, but not limited to, a corresponding standard industrial classification (SIC) code or a corresponding merchant classification code (MCC). Further, customer profile data 104A may also include, for the particular business customer, multiple data records that include corresponding elements of temporal data (e.g., a time or date stamp, etc.), and the multiple data records may establish, for the particular business customer, a temporal evolution in the street address or phone number of the particular business customer.

Account data 104B may also include a plurality of data records that identify and characterize one or more financial products issued by the financial institution to corresponding ones of the business customers. For example, the data records of account data 104B may include, for each of the financial products issued to corresponding ones of the business customers, one or more identifiers of the issued financial product (e.g., an account number, expiration data, card-security-code, etc.), one or more unique customer identifiers (e.g., an alphanumeric character string, such as a login credential, a customer name, etc.), information identifying a product type that characterizes the issued financial product or instrument, and additional information characterizing a balance or current status of the financial product (e.g., payment due dates or amounts, delinquent accounts statuses, etc.).

Examples of the issued financial products, and their corresponding product types, may include, but are not limited to, a demand deposit account (e.g., a savings account, a checking account), a term deposit account (e.g., a certificate of deposit), an investment or brokerage account, and one or more credit products, such as a credit-card account, a secured or unsecured line-of-credit, and/or an overdraft protection (ODP) product, as described herein. In some instances, and in addition to specifying the one or more identifiers of the credit products and the additional information characterizing the balance or current status of the credit products, the data records of account data 104B may also identify, for each of the credit products, one or more terms and conditions that include, but are not limited to, an amount of credit extended to the corresponding business customer, a repayment schedule, an interest rate, or a penalty imposed upon the corresponding business customer by the financial institution in response to a determined violation of the terms or conditions.

Transaction data 104C may include data records that identify, and characterize, transactions initiated by, and involving, the business customers of the financial institution and the financial products or instruments held by these business customers. The transactions may include purchase transactions may be initiated by a business customer of the financial institution and involve a corresponding counterparty (e.g., a merchant, retailer, or other business that offers products or services for sale), and may be funded by a corresponding one of the financial products or instruments issued by the financial institution and held by that business customer. In other examples, the transaction may also include other types of transactions initiated by, or involving, the business customers of the financial institution, such as, but not limited to, bill-payment transactions, electronic funds transfers, currency conversions, purchases or sales of securities, derivatives, or other tradeable instruments, electronic funds transfer (EFT) transactions, or peer-to-peer (P2P) transfers or transactions involving one or more of the financial products or instruments described herein. In some instances, and based on portions of account data 1046 and transaction data 104C, Fl computing system 130 may perform operations that compute values of metrics characterizing a utilization of one of more of the financial products or instruments by corresponding ones of the business customers and additionally, or alternatively, characterizing a temporal flow of funds into and out of one or more of the financial products or instruments held by corresponding ones of the business customers (e.g., a cash flow into, and out of, a business checking account held by a business customer of the financial institution).

Further, as illustrated in FIG. 1A, source system 102B may also be associated with, or operated by, the financial institution, and may maintain, within the corresponding one or more tangible, non-transitory memories, a source data repository 105 that includes one or more additional elements of interaction data 106. In some instances, the additional elements of interaction data 106 may include data records of delinquency data 106A that identify and characterize occurrences of prior delinquency events involving business customers of the financial institution and corresponding credit products issued by the financial institution, such as the credit products described herein. By way of example, each of the data records of delinquency data 106A may associated with a corresponding occurrence of an delinquency event, and may include, for the corresponding occurrence of the delinquency event, a unique identifier of a business customer involved in the delinquency event (e.g., an alphanumeric customer identifier, a customer name, etc.), information identifying a credit product held by the business customer and involved in the delinquency event (e.g., a corresponding product type, a corresponding portion of a tokenized account number, etc.), temporal data characterizing of the corresponding occurrence of the delinquency event (e.g., a due date of a missed payment scheduled for a credit product, such as a line-of-credit or an ODP, etc.), and additionally, or alternatively, information characterizing a scope of the corresponding occurrence of the delinquency event. The information characterizing the scope of the corresponding occurrence of the delinquency event may specify, among other things, a delinquent balance and a delinquency period (e.g., a temporal interval between a current date and the due date of the missed payment).

The data records of delinquency data 106A may also include, for the corresponding occurrence of the delinquency event, information that identifies each of the remediation processes or treatments implemented by the financial institution to resolve the corresponding occurrence of the delinquency event, and further temporal data that specifies a time or date on which the financial instruction implemented corresponding ones of the remediation processes or treatments. By way of example, the one or more remediation processes or treatments may include, but are not limited to, generating and provisioning, to the corresponding business customer, physical or electronic correspondence regarding the corresponding occurrence of the delinquency event (e.g., a physical letter, an email, a text-message, or an in-app notification, etc.), or initiating voice-based communications with the corresponding business customer (e.g., via a pre-recorded message delivered by telephone, via a call manually generated by a representative of the financial institution). Further, in some instances, the one or more remediation processes or treatments may also include, among other things, withdrawing funds from one or more accounts of the corresponding business customer based on a right of offset maintained by the financial institution, or performing operations that recover all, or a portion, of the past-due balance through interactions with a third-party collections agency. In other instances, and based on any of the customer-, account-, or delinquency- event-specific factors described herein, the one or more remediation processes or treatments may also include a deferral of any treatment of the delinquent business customer or the delinquent financial product or instrument.

Further, in some instances, the additional elements of interaction data 106 may include elements of aggregated industry data 106B that include values of one or more transaction or account parameters that characterize business customers of the financial institution associated with, or operating within, common industries, common types or classes of industries, and additionally, or alternatively, common subdivisions of the types or classes of industries. For example, each of the elements may be associated with a corresponding one of the industries, the common types or classes of industries, and/or the common subdivisions of the types or classes of industries, and may include a unique identifier of the corresponding one of the industries, types or classes of industries, and/or subdivisions of the types of classes of industries, such as, but not limited to, a corresponding SIC code or MCC. Further, the elements associated with each of the corresponding industries, types or classes of industries, and/or subdivisions of the types or classes may also include a value of one or more account or transaction parameters, which may characterize business customers of the financial institution that are associated with each of the corresponding industries, types or classes of industries, and/or subdivisions of the types or classes. Examples of these account or transaction parameters include, but are not limited to, a time-averaged balance within a business checking account, a time-averaged value of deposits into a business checking account, or a time-averaged value of transfers from a business banking account (e.g., a monthly average, a quarterly average, an average over a six-month interval, etc.). In some instances, and by comparing computed transaction or account parameter values associated with a particular business customer with the time-averaged transaction or account parameter values associated with similar business customer, Fl computing system 130 may perform operations, described herein, that identify and characterize deviations in the transaction or account parameter values associated with a particular business customer.

The disclosed embodiments are, however, not limited to these exemplary elements of customer profile data 104A, account data 104B, and transaction data 104C, or to these exemplary elements of delinquency data 106A and aggregated industry data 1066. In other instances, the elements of interaction data 104 may include any additional or alternate elements of data that identify and characterize the business customers of the financial institution and their relationships or interactions with the financial institution, financial products issued to these business customers by the financial institution, and transactions involving respective ones of the business customers and corresponding ones of the issued financial products or instruments described herein. Further, the elements of interaction data 106 may include any additional, or alternate, information identifying the characterizing the occurrences of the prior delinquency events, and the involved business customers and financial products, and any additional, or alternate, information characterizing the time-averaged or aggregated interactions of business customers of the financial institution associated with common industries, types or classes of industries, or subdivisions of the types or classes. Further, as illustrated in FIG. 1A, although stored within data repositories maintained by source system 102A and source system 1026, the exemplary elements of customer profile data 104A, account data 1046, and transaction data 104C, and the exemplary elements of delinquency data 106A and aggregated industry data 106B, may be maintained by any additional or alternate computing system associated with the financial institution, including, but not limited to, within one or more tangible, non-transitory memories of Fl computing system 130.

Source system 102C may be associated with, or operated by, one or more judicial, regulatory, governmental, or reporting entities external to, and unrelated to, the financial institution, such as a credit bureau, and source system 102C may maintain, within the corresponding one or more tangible, non-transitory memories, a source data repository 107 that includes one or more elements of interaction data 108 associated with one or more of the business customers of the financial institution. For example, the elements of interaction data 108 may include elements of credit-bureau data 108A that, for a business customer of the financial institution. may include, but are not limited to, a unique identifier of the business customer (e.g., an alphanumeric identifier or login credential, a customer name, etc.), a credit score of the business customer, information identifying one or more financial products or instruments currently or previously held by the business customer, information identifying a history of payments associated with these financial products or instruments, information identifying negative events associated with the business customer (e.g., missed payments, collections, repossessions, etc.), and/or information identifying one or more credit inquiries involving the business customer (e.g., inquiries by the financial institution, other financial institutions or business entities, etc.). The disclosed embodiments are, however, not limited to these exemplary elements of credit-bureau data 108A, and in other instances, interaction data 108 may include any additional or alternate elements of credit-bureau data, or data associated with the business customer and generated by the judicial, regulatory, governmental, or regulatory entities described herein.

In some instances, Fl computing system 130 may perform operations that establish and maintain one or more centralized data repositories within a corresponding ones of the tangible, non-transitory memories. For example, as illustrated in FIG. 1A, Fl computing system 130 may establish an aggregated data store 132, which maintains, among other things, elements of the interaction data ingested by Fl computing system 130 (e.g., from one or more of source systems 102) using any of the exemplary processes described herein. Aggregated data store 132 may, for instance, correspond to a data lake, a data warehouse, or another centralized repository established and maintained, respectively, by the distributed components of Fl computing system 130, e.g., through a Hadoop™ distributed file system (HDFS).

For example, Fl computing system 130 may execute one or more application programs, elements of code, or code modules that, in conjunction with the corresponding communications interface, establish a secure, programmatic channel of communication with each of source systems 102, including source system 102A, source system 102B, and source system 102C, across communications network 120, and may perform operations that access and obtain all, or a selected portion, of the elements of data maintained by corresponding ones of source systems 102. As illustrated in FIG. 1A, source system 102A may perform operations that obtain all, or a selected portion, of interaction data 104 (e.g., portions of the elements of customer profile data 104A, account data 104B, transaction data 104C) from source data repository 103, and transmit the obtained portions of interaction data 104 across communications network 120 to Fl computing system 130. Further, source system 102B may also perform operations that obtain all, or a selected portion, of interaction data 106 (e.g., portions of the elements of delinquency data 106A and aggregated industry data 106B) from source data repository 105, and transmit the obtained portions of interaction data 106 across communications network 120 to Fl computing system 130. Additionally, in some instances, source system 102C may also perform operations that obtain all, or a selected portion, of interaction data 108 (e.g., portions of the elements of credit-bureau data 108A) from source data repository 107, and transmit the obtained portions of interaction data 108 across communications network 120 to Fl computing system 130.

In some instances, and prior to transmission across communications network 120 to Fl computing system 130, source system 102A, source system 102B, and source system 102C may encrypt respective portions of interaction data 104, interaction data 106, and/or interaction data 108 using a corresponding encryption key, such as, but not limited to, a corresponding public cryptographic key associated with Fl computing system 130. Further, although not illustrated in FIG. 1A, each of source systems 102 may perform any of the exemplary processes described herein to obtain, encrypt, and transmit additional, or alternate, portions of the locally maintained customer profile, account, transaction, delinquency, aggregated industry, or credit bureau data across communications network 120 to Fl computing system 130.

A programmatic interface established and maintained by Fl computing system 130, such as application programming interface (API) 134, may receive the portions of interaction data 104, interaction data 106, and interaction data 104 from respective ones of source system 102A, source system 102B, and source system 102C. As illustrated in FIG. 1A, API 134 may route the portions of interaction data 104 (including the elements of customer profile data 104A, account data 104B, and transaction data 104C described herein), interaction data 106 (including the elements of delinquency data 106A and aggregated industry data 106B), and interaction data 108 (including the elements of credit-bureau data 108A) to a data ingestion engine 136 executed by the one or more processors of Fl computing system 130. As described herein, the portions of interaction data 104, delinquency data 106A, industry data 106B, and credit-bureau data 108A may be encrypted, and executed data ingestion engine 136 may perform operations that decrypt each of the encrypted portions of interaction data 104, 106, and/or 108 using a corresponding decryption key, e.g., a private cryptographic key associated with Fl computing system 130.

Executed data ingestion engine 136 may also perform operations that store the portions of interaction data 104 (including the elements of customer profile data 104A, account data 104B, and transaction data 104C described herein), interaction data 106 (including the elements of delinquency data 106A and aggregated industry data 106B described herein), and interaction data 108 (including the elements of credit-bureau data 108A described herein(within aggregated data store 132, e.g., as ingested customer data 138. As illustrated in FIG. 1A, a pre-processing engine 140 executed by the one or more processors of Fl computing system 130 may access the elements of ingested customer data 138, and perform any of the exemplary data-processing operations described herein to preprocess the accessed elements of ingested customer data 138 and to generate consolidated data records 142 that characterize corresponding ones of the business customers, their interactions with the financial institution and with other financial institutions, aggregated interactions involving similar business customers, and any associated delinquency events during a temporal interval associated with the ingestion of the elements of customer profile data 104A, account data 104B, and transaction data 104C, delinquency data 106A, aggregated industry data 106B, and credit-bureau data 108A by executed data ingestion engine 136.

By way of example, executed pre-processing engine 140 may access the elements of customer profile data 104A, account data 104B, and transaction data 104C, delinquency data 106A, aggregated industry data 106B, and credit-bureau data 108A (e.g., as maintained within ingested customer data 138). As described herein, each of the accessed data records may include an identifier of a corresponding business customer of the financial institution, such as a customer name or an alphanumeric character string. Additionally, executed pre-processing engine 140 may perform operations that map each of the accessed data records to a customer identifier assigned to the corresponding business customer by Fl computing system 130. By way of example, Fl computing system 130 may assign a unique, alphanumeric customer identifier to each business customer, and executed pre-processing engine 140 may perform operations that parse the accessed data records, identify each of the parsed data records that identifies the corresponding business customer using a customer name, and replace that customer name with the corresponding alphanumeric customer identifier.

Executed pre-processing engine 140 may also perform operations that assign a temporal identifier to each of the accessed data records, and that augment each of the accessed data records to include the newly assigned temporal identifier. In some instances, the temporal identifier may associate each of the accessed data records with a corresponding temporal interval, which may be indicative of reflect a regularity or a frequency at which Fl computing system 130 ingests the elements of customer profile data 104A, account data 104B, and transaction data 104C, delinquency data 106A, aggregated industry data 106B, and credit-bureau data 108A. For example, executed data ingestion engine 136 may receive elements of confidential data from corresponding ones of source systems 102 on a daily basis, a weekly basis, or a monthly basis, and in particular, may receive and store the elements of customer profile data 104A, account data 104B, and transaction data 104C, delinquency data 106A, aggregated industry data 106B, and credit-bureau data 108A from corresponding ones of source systems 102 on Apr. 30, 2022.

For example, executed pre-processing engine 140 may generate a temporal identifier associated with the regular, monthly ingestion of the elements of customer profile data 104A, account data 104B, and transaction data 104C, delinquency data 106A, aggregated industry data 106B, and credit-bureau data 108A on Apr. 30, 2022 (e.g., “2022-4-301”), and may augment the accessed elements of customer profile data 104A, account data 104B, and transaction data 104C, delinquency data 106A, aggregated industry data 106B, and credit-bureau data 108A to include the generated temporal identifier. The disclosed exemplary embodiments are, however, not limited to temporal identifiers reflective of a monthly ingestion of the elements of customer profile data 104A, account data 104B, and transaction data 104C, delinquency data 106A, aggregated industry data 106B, and credit-bureau data 108A by Fl computing system 130, and in other instances, executed pre-processing engine 140 may augment the accessed data records to include temporal identifiers reflective of any additional, or alternative, temporal interval during which Fl computing system 130 ingests the elements of customer profile data 104A, account data 104B, and transaction data 104C, delinquency data 106A, aggregated industry data 106B, and credit-bureau data 108A.

In some instances, executed pre-processing engine 140 may perform further operations that, for a particular business customer of the financial institution during the temporal interval (e.g., represented by a pair of the customer and temporal identifiers described herein and a corresponding industry identifier, such as the SIC code or MCC described herein), obtain one or more of the elements of customer profile data 104A, account data 104B, and transaction data 104C, delinquency data 106A, aggregated industry data 106B, and credit-bureau data 108A that include the pair of customer and temporal identifiers and in some instances, the industry identifier. Executed pre-processing engine 140 may perform operations that consolidate the obtained data elements and generate a corresponding one of consolidated data records 142 that includes the customer identifier, temporal identifier, and industry identifier, and that is associated with, and characterizes, the particular business customer of the financial institution across the temporal interval. By way of example, executed pre-processing engine 140 may consolidate the obtained data elements, which include the pair of customer and temporal identifiers, and the industry identifier, through an invocation of an appropriate Java-based SQL “join” command (e.g., an appropriate “inner” or “outer” join command, etc.).

Further, executed pre-processing engine 140 may perform any of the exemplary processes described herein to generate another one of consolidated data records 142 for each additional, or alternate, business customer of the financial institution during the temporal interval (e.g., as represented by a corresponding customer identifier and the temporal interval). In some instances, executed pre-processing engine 140 may perform operations that store each of consolidated data records 142 within one or more tangible, non-transitory memories of Fl computing system 130, such as consolidated data store 144. Consolidated data store 144 may, for example, correspond to a data lake, a data warehouse, or another centralized repository established and maintained, respectively, by the distributed components of Fl computing system 130, e.g., through a Hadoop™ distributed file system (HDFS).

In some instances, and as described herein, consolidated data records 142 may include a plurality of discrete data records, each of these discrete data records may be associated with, and may maintain data characterizing, a corresponding one of the business customers of the financial institution during the corresponding temporal interval (e.g., a month-long interval extending from Apr. 1, 2022, to Apr. 30, 2022). By way of example, and for a particular customer of the financial institution, discrete data record 142A of consolidated data records 142 may include a customer identifier 146 of the particular business customer (e.g., an alphanumeric character string “CUSTID”), a temporal identifier 148 of a corresponding temporal interval (e.g., a numerical string “2022-4-30”), an industry identifier 150 associated with the particular business customer (e.g., a corresponding SIC code or MCC). Discrete data record 142A may also include data elements 152 of consolidated data that identify and characterize the particular business customer during the corresponding temporal interval, and data elements 153 of aggregated industry data that include aggregated or averaged values of transaction or account parameters characterizing other business customers associated with industry identifier 150. For instance, consolidated data elements 152 may include, among other things, one or more of the elements of customer profile data 104A, account data 104B, and transaction data 104C, delinquency data 106A, and credit-bureau data 108A associated with the particular business customer and ingested by Fl computing system 130 on Apr. 30, 2022, and aggregated industry data elements 153 may include one or more of the elements of aggregated industry data 106B that include, or reference, industry identifier 150 of the particular business customer, such as those described herein.

Referring to FIG. 1B, a filtration engine 151 executed by the one or more processors of Fl computing system 130 may access each of the data records of consolidated data records 142 maintained within consolidated data store 144 (e.g., data record 142A, as described herein), and perform operations that filter the accessed data records of consolidated data records 142 in accordance with one or more filtration or exclusion criteria. By way of example, and based on the one or more filtration criteria, executed filtration engine 151 may identify subsets of the data records of consolidated data records 142 that characterize, respectively, business customers that hold credit products (e.g., the unsecured lines-of-credit or ODPs described herein) for at least a predetermined temporal interval (e.g., six months, etc.) prior to the ingestion of the corresponding elements of customer profile and account data by Fl computing system 130. Further, and based on the one or more filtration criteria, executed filtration engine 151 may also perform operations that parse the data records of the identified subsets of consolidated data records 142, and exclude (e.g., “filter out”) those data records that characterize business customers involved in delinquency events associated with corresponding ones of the credit products and characterized by corresponding pendency periods that exceed a first threshold duration, such as the predetermined, thirty-day pendency period described herein. In some instances, executed filtration engine 151 may determine that the remaining data records within the identified subsets (e.g., “filtered” data records) are suitable for training and validating the machine-learning or artificial intelligence processes described herein, and executed filtration engine 151 may perform operations that store the filtered data records within a corresponding portion of consolidated data store 144, e.g., as filtered data records 154.

For example, as illustrated in FIG. 1B, executed filtration engine 151 may access discrete data record 142A of consolidated data records 142, which includes, among other things, customer identifier 146 of the particular business customer (e.g., an alphanumeric character string “CUSTID”), temporal identifier 148 of the corresponding temporal interval (e.g., a numerical string “2022-4-30”), consolidated data elements 152, and aggregated industry data elements 153. In some instances, executed filtration engine 151 may perform operations that parse consolidated data elements 152 and obtain information (described herein) that confirms the particular business customer is associated with a delinquency event involving a credit product issued at least six months prior to a current date or time, and that the delinquency interval associated with the delinquency event fails to exceed the first predetermined pendency period, e.g., thirty days. As such, executed filtration engine 151 may determine that data record 142A is suitable for training and validating the machine-learning or artificial intelligence processes described herein, and executed filtration engine 151 may perform operations that store data record 142A within an additional portion of consolidated data store 144, e.g., as one or filtered data records 154.

Executed filtration engine 151 may access each of the additional data records of consolidated data records 142, and may perform any of the exemplary processes described herein to establish a consistency, or an inconsistency, between each of the additional data records and the filtration or exclusion criteria described herein. Based on the established consistency with all, or a selected subset, or these filtration criteria, executed filtration engine 151 may perform operations that store corresponding ones of the additional data records within filtered data records 154. Further, as illustrated in FIG. 1B consolidated data store 144 may maintain each of filtered data records 154 in conjunction with additional filtered data records 164. In some instances, executed pre-processing engine 140 and executed filtration engine 151 may perform any of the exemplary processes described herein, either individually or collectively, to generate each of the additional filtered data records 164 based on elements of customer profile, account, transaction, delinquency, aggregated industry, and/or credit bureau data ingested from source systems 102 during the corresponding prior temporal intervals.

For example, additional filtered data records 164 may include one or more discrete data records, such as discrete data record 165, associated with a prior temporal interval extending from Mar. 1, 2022, to Mar. 31, 2022. For a particular business customer of the financial institution, discrete data record 165 of additional filtered data records 164 may include a customer identifier 166 of the particular business customer (e.g., an alphanumeric character string “CUSTID”), a temporal identifier 167 of a corresponding temporal interval (e.g., a numerical string “2022-3-31”), an industry identifier 167A associated with the particular business customer (e.g., a corresponding SIC code or MCC). Discrete data record 165 may also include data elements 168 of consolidated data that identify and characterize the particular business customer during the prior temporal interval extending from Mar. 1, 2022, to Mar. 31, 2022 (e.g., as consolidated from the data records ingested by Fl computing system 130 on Apr. 30, 2021), and data elements 169 of aggregated industry data that include the aggregated or averaged transaction or account parameters values characterizing other business customers associated with industry identifier 167A.

The disclosed exemplary embodiments are, however, not limited to the exemplary consolidated or filtered data records described herein, or to the exemplary temporal intervals described herein. In other examples, Fl computing system 130 may generate, and the consolidated data store 144 may maintain, any additional or alternate number of discrete sets of filtered data records, having any additional or alternate composition, that would be appropriate to the elements of interaction or credit bureau data ingested by Fl computing system 130 at the predetermined intervals described herein. Further, in some examples, Fl computing system 130 may ingest elements of interaction or credit bureau data from source systems 102 at any additional, or alternate, fixed or variable temporal interval that would be appropriate to the ingested data.

In some instances, Fl computing system 130 may perform any of the exemplary operations described herein to train adaptively a machine-learning or artificial-intelligence process to predict, at a temporal prediction point, a likelihood of an occurrence of default event involving a business customer of a financial institution and a credit product issued by that financial institution during a predetermined, future temporal interval using training datasets associated with a first prior temporal interval (e.g., a “training” interval), and using validation datasets associated with a second, and distinct, prior temporal interval (e.g., an out-of-time “validation” interval). As described herein, the business customer may be associated with a delinquency event involving the credit product, and at the temporal prediction point, the delinquency event may be characterized by a pendency period that fails to exceed a first threshold duration, such as, but not limited to, thirty calendar days. Further, as described herein, the default event involving the business customer and the credit product may occur during the future temporal interval when the delinquency event remains pendant for a period that is equivalent to, or that exceeds, a second threshold duration, such as, but not limited to, sixty calendar days.

As described herein, the machine-learning or artificial-intelligence process may include an ensemble or decision-tree process, such as a gradient-boosted decision-tree process (e.g., XGBoost model), and the training and validation datasets may include, but are not limited to, values of adaptively selected features obtained, extracted, or derived from the filtered data records maintained within consolidated data store 144, e.g., from data elements maintained within the discrete data records of filtered data records 154 or the additional filtered data records 164. In some examples, described herein, the training and validation datasets may include elements of data. Examples of the elements of data of the training and validation datasets include feature values characterizing delinquent credit products as described herein that the business customers that hold these delinquent credit products, and other business customers of the financial institution that are similar to, and operate in common industries, industry types, or industry sub-types, as the business customers that hold these delinquent credit products.

Further, and by way of example, the distributed computing components of Fl computing system 130 (e.g., that include one or more GPUs or TPUs configured to operate as a discrete computing cluster) may perform any of the exemplary processes described herein to adaptively train the machine learning or artificial intelligence process (e.g., the gradient-boosted, decision-tree process) in parallel through an implementation of one or more parallelized, fault-tolerant distributed computing and analytical processes. Based on an outcome of these adaptive training processes, Fl computing system 130 may generate model coefficients, parameters, thresholds, and other modelling data that collectively specify the trained machine learning or artificial intelligence process, and may store the generated model coefficients, parameters, thresholds, and modelling data within a portion of the one or more tangible, non-transitory memories, e.g., within consolidated data store 144.

Referring to FIG. 1C, a training engine 172 executed by the one or more processors of Fl computing system 130 may access the filtered data records maintained within consolidated data store 144, such as, but not limited to, filtered data records 154 and/or additional filtered data records 164. As described herein, each of the filtered data records, such as discrete data record 142A of filtered data records 154, or discrete data record 165 of additional filtered data records 164, may include a customer identifier of a corresponding one of the business customers of the financial institution (e.g., customer identifiers 146 and 166 of FIG. 1B), a temporal identifier that associates the filtered data record with a corresponding temporal interval (e.g., temporal identifiers 148 and 167 of FIG. 1B), and industry identifier associated with the corresponding business customer, such as an SIC code or MCC (e.g., industry identifiers 150 and 167A of FIG. 1B). Further, as described herein, each of the filtered data records may include consolidated elements of customer profile, account, transaction, delinquency, or credit-bureau data that characterize the corresponding one of the business customers during the corresponding temporal interval (e.g., consolidated data elements 152 and 168 of FIG. 1B), and elements of aggregated industry data that include the aggregated or averaged transaction or account parameters values characterizing the other business customers associated with the corresponding industry identifier (e.g., aggregated industry data elements 153 and 169 of FIG. 1B). Each of the filtered data records may also satisfy one or more filtration or exclusion criteria, such as those described herein.

In some instances, executed training engine 172 may parse the filtered data records, and based on corresponding ones of the temporal identifiers, determine that the consolidated elements of customer profile, account, transaction, delinquency, or credit-bureau data characterize delinquent credit products (e.g., the credit products described herein) held by corresponding business customers across a range of prior temporal intervals. Further, executed training engine 172 may also perform operations that decompose the determined range of prior temporal intervals into a corresponding first subset of the prior temporal intervals (e.g., the “training” interval described herein) and into a corresponding second, subsequent, and disjoint subset of the prior temporal intervals (e.g., the “validation” interval described herein). For example, as illustrated in FIG. 1D, the range of prior temporal intervals (e.g., shown generally as At along timeline 173 of FIG. 1D) may be bounded by, and established by, temporal boundaries tᵢ and t_{f}. Further, the decomposed first subset of the prior temporal intervals (e.g., shown generally as training interval Δt_{training} along timeline 173 of FIG. 1D) may be bounded by temporal boundary tᵢ and a corresponding splitting point tsₛₚₗᵢₜ along timeline 173, and the decomposed second subset of the prior temporal intervals (e.g., shown generally as validation interval Δt_{validation} along timeline 173 of FIG. 1D) may be bounded by splitting point tₛₚₗᵢₜ and temporal boundary t_{f}.

Referring back to FIG. 1C, executed training engine 172 may generate elements of splitting data 174 that identify and characterize the determined temporal boundaries (e.g., temporal boundaries tᵢ and t_{f}) and the range of prior temporal intervals established by the determined temporal boundaries The elements of splitting data 174 may also identify and characterize the splitting point (e.g., the splitting point tₛₚₗᵢₜ described herein), the first subset of the prior temporal intervals (e.g., the training interval Δt_{training} described herein), and the second, and subsequent subset of the prior temporal intervals (e.g., the validation interval Δt_{validation} described herein). As illustrated in FIG. 1C, executed training engine 172 may store the elements of splitting data 174 within the one or more tangible, non-transitory memories of FI computing system 130, e.g., within consolidated data store 144.

In some instances, each of the prior temporal intervals may correspond to a one-month interval, and executed training engine 172 may perform operations that establish adaptively the splitting point between the corresponding temporal boundaries such that a predetermined first percentage of the consolidated data records are associated with temporal intervals (e.g., as specified by corresponding ones of the temporal identifiers) disposed within the training interval, and such that a predetermined second percentage of the consolidated data records are associated with temporal intervals (e.g., as specified by corresponding ones of the temporal identifiers) disposed within the validation interval. By way of example, executed training engine 172 may compute one or both of the first and second predetermined percentages, and establish the splitting point, based on the range of prior temporal intervals, a quantity or quality of the consolidated data records maintained within consolidated data store 144, or a magnitude of the temporal intervals (e.g., one-month intervals, two-week intervals, one-week intervals, one-day intervals, etc.).

In some examples, a training input module 176 of executed training engine 172 may perform operations that access the filtered data records maintained within consolidated data store 144. Based on portions of splitting data 174, executed training input module 176 may perform operations that parse the filtered data records and determine: (i) a first subset 178A of these consolidated data records are associated with the training interval Δt_{training} and may be appropriate to training adaptively the gradient-boosted decision model during the training interval; and a (ii) second subset 178B of these consolidated data records are associated with the validation interval Δt_{validation} and may be appropriate to validating the trained gradient-boosted decision model during the validation interval.

Prior to partitioning the filtered data records maintained within consolidated data store 144 into corresponding ones of first subset 178A and second subset 178B, executed training input module 176 may perform operations that augment each of the filtered data records (e.g., filtered data records 154 and 164, etc.) to include additional data characterizing a ground truth associated with the corresponding customer and temporal interval (as established by the corresponding pair of customer and temporal identifiers). For example, and for a particular one of the filtered data records, such as discrete data record 142A of filtered data records 154, executed training input module 176 may obtain customer identifier 146 (e.g., “CUSTID”), which identifies the corresponding business customer, and may obtain temporal identifier 148, which indicates data record 142A is associated with an ingestion date of Apr. 30, 2022. As described herein, consolidated data elements 152 of discrete data record 142A may include elements of consolidated customer profile, account, transaction, delinquency, or credit-bureau data, which may specify, among other things, that the corresponding business customer is involved in a delinquency event associated with a credit product, such as an unsecured line-of-credit issued to the business customer by the financial institution. The elements of consolidated customer profile, account, transaction, delinquency, or credit-bureau data maintained within consolidated data elements 152 may also specify that a temporal initiation point tᵢₙᵢₜ for delinquency event corresponds Apr. 10, 2022, and that, as of Apr. 30, 2022, a pendency period associated with the delinquency event corresponds to twenty calendar days (e.g., less than the first threshold duration of thirty calendar days, as described herein).

Further, and based on customer identifier 146 and temporal identifier 148, executed training input module 176 may access aggregated data store 132, and obtain additional elements of delinquency data ingested by the Fl computing system, e.g., subsequent to the ingestion date of Apr. 30, 2022. In some instances, and based on the additional elements of delinquency data, executed training input module 176 determine whether the pendency period of the delinquency event exceeds, or becomes equivalent to, a second threshold duration (e.g., the second predetermined time period of sixty calendar days, as described herein) within a target temporal interval Δt_{target} (e.g., the predetermined time period of eight months, as described herein), and as such, whether the corresponding business customer is associated with an actual occurrence, or non-occurrence, of a default event involving the credit product within target temporal interval Δt_{target} (e.g., whether the corresponding business customer represents a respective one of a “positive,” or “negative,” target for training and validating adaptively the machine learning or artificial intelligence process described herein).

In some instances, executed training input module 176 may package data characterizing a positive target (e.g., the actual occurrence of the default event involving the credit product within target temporal interval Δt_{target}) or a negative target (e.g., the non-occurrence of the default event involving the credit product within target temporal interval Δt_{target}) into a portion of the ground-truth data associated with data record 142A filtered data records 154, and may augment data record 142A of filtered data records 154 (e.g., as maintained within consolidated data store 144) to include the ground-truth data. Executed training input module 176 may also perform any of the exemplary processes described herein to generate and append an appropriate element of ground-truth data to each additional, or alternate, one of the filtered data records maintained within consolidated data store 144 (e.g., filtered data records 154 and 164, etc.).

Executed training input module 176 may also perform operations that partition the filtered data records into subsets suitable for training adaptively the machine-learning or artificial intelligence process (e.g., which may be maintained in first subset 178A of filtered data records within consolidated data store 144) and for validating the trained machine-learning or artificial intelligence processes (e.g., which may be maintained in second subset 178B of filtered data records within consolidated data store 144). By way of example, executed training input module 176 may access splitting data 174, and establish the temporal boundaries for the training interval Δt_{training} (e.g., tem poral boundary tᵢ and splitting point tₛₚₗᵢₜ) and the validation interval Δt_{training} (e.g., splitting point tₛₚₗᵢₜ and temporal boundary t_{f}). Further, executed training input module 176 may also parse each of the filtered data records maintained within consolidated data store 144 (e.g., filtered data records 154 and 164, etc.), access the corresponding temporal identifier, and determine the temporal interval associated with the each of the filtered data records.

If, for example, executed training input module 176 were to determine that the temporal interval associated with a corresponding one of the filtered data records is disposed within the temporal boundaries for the training interval Δt_{training} executed training input module 176 may determine that the corresponding one of the filtered data records may be suitable for training, and may perform operations that include the corresponding one of the filtered data records within a portion of the first subset 178A (e.g., that store the corresponding one of the filtered data records within a portion of consolidated data store 144 associated with first subset 178A). Alternatively, if executed training input module 176 were to determine that the temporal interval associated with a corresponding one of the filtered data records is disposed within the temporal boundaries for the validation interval Δt_{validation} executed training input module 176 may determine that the corresponding one of the filtered data records may be suitable for validation, and may perform operations that include the corresponding one of the filtered data records within a portion of the second subset 178B (e.g., that store the corresponding one of the filtered data records within a portion of consolidated data store 144 associated with second subset 178B). Executed training input module 176 may perform any of the exemplary processes described herein to determine the suitability of each additional, or alternate, one of the filtered data records maintained within consolidated data store 144 for adaptive training, or alternatively, validation, of the gradient-boosted, decision-tree process.

Further, in some instances, the filtered data records within first subset 178A and second subset 178B may represent an imbalanced data set in which the actual occurrences of default events within the target temporal interval are outnumbered disproportionately by non-occurrences of default events within the target temporal interval (e.g., as established by the elements of ground-truth data appended for the filtered data records of first subset 178A and second subset 178B, as described herein). Based on the imbalanced character of first subset 178A and second subset 178B, executed training input module 176 may perform operations that, based on corresponding elements of ground-truth data, downsample the filtered data records within first subset 178A and second subset 178B that are associated with the non-occurrences of default events (e.g., as established by the appended elements of ground-truth data), and the downsampled data records maintained within each first subset 178A and second subset 178B may represent balanced data sets characterized by a more proportionate balance between the occurrences and non-occurrences of the default events within the target temporal interval Δt_{target} subsequent to the temporal initiation point tᵢₙᵢₜ of the corresponding delinquency events.

Each of the plurality of training datasets 180 may also include elements of data (e.g., feature values) that characterize the corresponding one of the business customers and the corresponding business customer's interaction with the financial institution, with other financial institutions, and with financial products issued by the financial institution, such as, but not limited to the credit products described herein. Further, each of training datasets 180 may also include the corresponding element ground-truth data indicative of occurrence, or non-occurrence, of a default event involving the corresponding business customer and the credit product within the target temporal interval subsequent to the occurrence of the corresponding delinquency event (e.g., the positive or negative targets described herein, as maintained within respective ones of the filtered data records maintained within first subset 178A).

In some instances, executed training input module 176 may perform operations that identify, and obtain or extract, one or more of the features values from the filtered data records maintained within first subset 178A and associated with the corresponding one of the business customers. For example, the obtained or extracted feature values may include elements of the customer profile, account, transaction, delinquency, aggregated industry, or credit-bureau data described herein, which may populate collectively the filtered data records maintained within first subset 178A. Further, in some instances, executed training input module 176 may perform operations that compute, determine, or derive one or more of the features values based on elements of data extracted or obtained from the filtered data records maintained within first subset 178A. Examples of these computed, determined, or derived feature values include, but are not limited to, a computed, determined, or derived value characterizing a utilization of available credit in one or more of the credit products by corresponding one of the business customers across one or more temporal intervals, an aggregated transaction amount across all, or a subset, of financial accounts held by corresponding one of the business customers during one or more prior temporal intervals, a net flow of cash into, or out of, a financial account (e.g., a demand deposit account, etc.) held by the corresponding one of the business customers during one or more prior temporal intervals, and/or aggregated value of one or more types of initiated transactions (e.g., electronic fund transfers, etc.) involving a financial account held by the corresponding one of the business customers during one or more prior temporal intervals.

Further, in some examples, the computed, determined, or derived feature values may include one or more “normalized” feature values that, for a corresponding business customer of the financial institution associated with a particular industry type or class or a particular subdivision of the industry type or class, characterize an account-based, transactional, or financial behavior of the corresponding business customer relative to comparable account-based, transactional, or financial behavior of other business customers that operate within the particular industry type or class, or the particular subdivision of the industry type or class, associated with the corresponding business customer (e.g., that share a common SIC code or MCC with the corresponding business customer). For instance, these normalized feature values may include, but are not limited to, a ratio between a quarterly revenue of the corresponding business and an average quarterly revenue of the other business customers across one or more prior financial quarters, a ratio between an aggregate cash flow of the corresponding business customer and an average aggregate cash flow a ratio between a quarterly revenue of the corresponding business and an average quarterly revenue of the other business customers during each of a plurality of prior months, or a ratio between a maximum duration of a delinquency event involving a credit account held by the corresponding customer and an average maximum duration of delinquency events involving the other business customers during each of a plurality of prior months, quarters, or other reporting periods.

In some instances, an inclusion of one or more normalized feature values, such as those described herein, within one or more of training datasets 180 may Fl computing system 130 to train adaptively the machine-learning or artificial intelligence processes against not only on data characterizing fluctuations in the account-based, transactional, or financial behavior of corresponding ones of the business customers, but also based on normalized data charactering whether these fluctuations are comparable to, or deviate from, fluctuations in the account-based, transactional, or financial behaviors additional customers of the financial institution that operate within similar industry types or classes or similar subdivisions of the industry types or classes. The disclosed exemplary embodiments are, however, not limited to these obtained or extracted feature values, or these computed, determined, or derived feature values, and in other instances, training datasets 180 may include any additional or alternate features obtained, extracted, computed, determined, or derived from the elements of customer profile, account, transaction, delinquency, aggregated industry, or credit-bureau data that populate the filtered data records of first subset 178A.

As illustrated in FIG. 1C, executed training input module 176 may provide training datasets 180 (which include the corresponding elements of ground-truth data) as inputs to an adaptive training and validation module 182 of executed training engine 172. In some instances, and upon execution by the one or more processors of Fl computing system 130, executed adaptive training and validation module 182 may perform operations that adaptively train the machine-learning or artificial-intelligence process against the elements of training data included within each of training datasets 180. By way of example, and as described herein, the machine-learning or artificial-intelligence process may include a gradient-boosted, decision-tree process, and executed adaptive training and validation module 182 may perform operations that establish a plurality of nodes and a plurality of decision trees for the gradient-boosted, decision-tree process, which may ingest and process the elements of training data (e.g., the customer identifiers, the temporal identifiers, the feature values, etc.) maintained within each of the plurality of training datasets 180. Based on the execution of adaptive training and validation module 182, and on the ingestion of each of training datasets 180 by the established nodes of the gradient-boosted, decision-tree process, Fl computing system 130 may perform operations that adaptively train the gradient-boosted, decision-tree process against the elements of training data included within each of training datasets 180.

In some examples, the distributed components of Fl computing system 130 may execute adaptive training and validation module 182, and may perform any of the exemplary processes described herein in parallel to train adaptively the machine-learning or artificial-intelligence process against the elements of training data included within each of training datasets 180. The parallel implementation of adaptive training and validation module 182 by the distributed components of Fl computing system 130 may be based on an implementation, across the distributed components, of one or more of the parallelized, fault-tolerant distributed computing and analytical protocols described herein (e.g., the Apache Spark™ distributed, cluster-computing framework, etc.).

Further, and as described herein, executed adaptive training and validation module 182 may perform operations that adaptively train the machine-learning or artificial-intelligence process (e.g., the gradient-boosted, decision-tree process described herein) to predict, at any temporal point during a pendency of a delinquency event involving a corresponding business customer and a credit product, a likelihood of an occurrence of a default event involving the business customer and the credit product within target temporal interval Δt_{target} disposed subsequent to the occurrence of the delinquency event. The delinquency event may, for example, occur when the corresponding business customer fails to submit a scheduled payment associated with the corresponding credit product (e.g., when that scheduled payment becomes “past due”), and referring to FIG. 1E, the occurrence (or initiation) of the delinquency event may be characterized by a temporal initiation point tᵢₙᵢₜ along timeline 179, and a temporal prediction point t_{pred} along timeline 179 may be disposed at, or less than, thirty days subsequent to, the temporal initiation point tinit along timeline 179 (e.g., the first threshold duration descried herein).

Further, as illustrated in FIG. 1E, executed training engine 172 may perform any of the exemplary processes described herein to train adaptively machine-learning or artificial-intelligence process (e.g., the gradient-boosted, decision-tree process described herein) to predict the likelihood of occurrences of default events during a future, target temporal interval Δt_{target} based on input datasets associated with a corresponding prior extraction interval Δt_{extract}. Additionally, the target temporal interval Δt_{target} may be separated temporally from the temporal prediction point t_{pred} by a corresponding buffer interval Δt_{buffer}. In some instances, the target temporal interval Δt_{target} may be characterized by a predetermined duration, such as, but not limited to, eight months, and the prior extraction interval Δt_{extract} may be characterized by a corresponding, predetermined duration, such as, but not limited to, six months. Further, in some examples, the buffer interval Δt_{buffer} may also be associated with a predetermined duration, such as, but not limited to, one month. Additionally, the predetermined duration of buffer interval Δt _{buffer} may established by Fl computing system 130 to separate temporally the business customers' prior interactions with the financial institution (and with other financial institutions) from the future target temporal interval Δt_{target}.

Referring back to FIG. 1C, and through the performance of these adaptive training processes, executed adaptive training and validation module 182 may perform operations that compute one or more candidate process parameters that characterize the trained machine-learning or artificial-intelligence process (e.g., the trained gradient-boosted, decision-tree process described herein), and package the candidate process parameters into corresponding portions of candidate parameter data 184. In some instances, the candidate process parameters included within candidate parameter data 184 may include, but are not limited to, a learning rate associated with the trained, gradient-boosted, decision-tree process, a number of discrete decision trees included within the trained, gradient-boosted, decision-tree process (e.g., the “n_estimator” for the trained, gradient-boosted, decision-tree process), a tree depth characterizing a depth of each of the discrete decision trees included within the trained, gradient-boosted, decision-tree process, a minimum number of observations in terminal nodes of the decision trees, and/or values of one or more hyperparameters that reduce potential model overfitting (e.g., regularization of pseudo-regularization hyperparameters). Further, and based on the performance of these adaptive training processes, executed adaptive training and validation module 182 may also generate candidate input data 186, which specifies a candidate composition of an input dataset for the trained, machine-learning or artificial-intelligence process (e.g., which be provisioned as inputs to the nodes of the decision trees of the trained, gradient-boosted, decision-tree process).

As illustrated in FIG. 1C, executed adaptive training and validation module 182 may provide candidate parameter data 184 and candidate input data 186 as inputs to executed training input module 176 of training engine 172, which may perform any of them exemplary processes described herein to generate a plurality of validation datasets 188 having compositions consistent with candidate input data 186. As described herein, the plurality of validation datasets 188 may, when provisioned to, and ingested by, the nodes of the decision trees of the trained, gradient-boosted, decision-tree process, enable executed training engine 172 to validate the predictive capability and accuracy of the trained, gradient-boosted, decision-tree process, for example, based on elements of ground truth data incorporated within the validation datasets 188, or based on one or more computed metrics, such as, but not limited to, computed precision values, computed recall values, and computed area under curve (AUC) for receiver operating characteristic (ROC) curves or precision-recall (PR) curves.

In some instances, executed training input module 176 may parse candidate input data 186 to obtain the candidate composition of the input dataset, which not only identifies the candidate elements of customer-specific data included within each validation dataset (e.g., the candidate feature values described herein), but also a candidate sequence or position of these elements of customer-specific data within the validation dataset. Examples of these candidate feature values include, but are not limited to, one or more of the feature values extracted, obtained, computed, determined, or derived by executed training input module 176 and packaged into corresponding potions of training datasets 180, as described herein.

By way of example, each of the plurality of validation datasets 188 may be associated with a corresponding one of the business customers of the financial institution and a corresponding temporal interval, and may include, among other things a customer identifier associated with that corresponding business customer and a temporal identifier representative of the corresponding temporal interval, as described herein within the validation interval Δt_{validation}. Further, and for each of the plurality of validation datasets 188, the corresponding business customer may hold a credit product issued by the financial institution, and as described herein, the corresponding business customer may be associated with a corresponding delinquency event that involves the credit product, that is initiated during the corresponding temporal interval, or remains pending and unresolved during at least a portion of the corresponding temporal interval, and that is associated with a pendency of less that the first threshold duration, e.g., thirty calendar days.

Further, in some examples, executed training input module 176 may access the consolidated data records maintained within second subset 178B of consolidated data store 144, and may perform operations that extract, from an initial one of the consolidated data records, a customer identifier (which identifies a corresponding one of the customers of the financial institution associated with the initial one of the consolidated data records) and a temporal identifier (which identifies a temporal interval associated with the initial one of the consolidated data records). Executed training input module 176 may package the extracted customer identifier and temporal identifier into portions of a corresponding one of validation datasets 188, e.g., in accordance with candidate input data 186.

Executed training input module 176 may perform operations that access one or more additional ones of the consolidated data records that are associated with the corresponding one of the customers (e.g., that include the customer identifier) and as associated with a temporal interval (e.g., based on corresponding temporal identifiers) disposed prior to the corresponding temporal interval, e.g., within the extraction interval textract described herein. Based on portions of candidate input data 186, executed training input module 176 may identify, and obtain or extract one or more of the feature values of the validation datasets from within the additional ones of the consolidated data records within second subset 178B. Further, in some examples, and based on portions of candidate input data 186, executed training input module 176 may perform operations that compute, determine, or derive one or more of the features values based on elements of data extracted or obtained from further ones of the consolidated data records within second subset 178B. Executed training input module 176 may package each of the obtained, extracted, computed, determined, or derived feature values into corresponding positions within the initial one of validation datasets 188, e.g., in accordance with the candidate sequence or position specified within candidate input data 186.

Further, executed training input module 176 may package, into an appropriate position within portion of the corresponding one of validation datasets 188, an element of ground-truth data indicative of the presence or absence of a service-specific attrition event associated with the corresponding one of the customers within the target interval Δt_{target} (e.g., such as, but not limited to, a three-month period disposed within three and six months subsequent to the prediction date or time). For example, executed training input module 176 may parse the initial one of the consolidated data records, obtain a corresponding element of ground-truth data (e.g., the positive or negative targets, as described herein), and package the extracted element of ground-truth data into the appropriate position within the corresponding one of validation datasets 188, e.g., in accordance with the candidate sequence or position specified within candidate input data 186.

In some instances, executed training input module 176 may perform any of the exemplary processes described herein to generate additional, or alternate, ones of validation datasets 188 based on the elements of data maintained within the consolidated data records of second subset 178B. For example, each of the additional, or alternate, ones of validation datasets 188 may be associated with a corresponding, and distinct, pair of customer and temporal identifiers, and as such, corresponding business customers of the financial institution and corresponding temporal intervals within validation interval Δt_{validation}. Further, executed training input module 176 may perform any of the exemplary processes described herein to generate an additional, or alternate, ones of validation datasets 188 associated with each unique pair of customer and temporal identifiers maintained within the consolidated data records of second subset 178B, and in other instances a number of discrete validation datasets within validation datasets 188 may be predetermined or specified within candidate input data 186.

Referring back to FIG. 1C, executed training input module 176 may provide the plurality of validation datasets 188 as inputs to executed adaptive training and validation module 182. In some examples, executed adaptive training and validation module 182 may perform operations that apply the trained, machine-learning or artificial-intelligence process (e.g., the trained, gradient-boosted, decision-tree process) to respective ones of validation datasets 188 (e.g., based on the candidate process parameters within candidate parameter data 184, as described herein), and that generate elements of output data based on the application of the trained, machine-learning or artificial-intelligence process to the respective ones of validation datasets 188.

As described herein, each of the each of elements of output data may be generated through the application of the trained, machine-learning or artificial-intelligence process to a corresponding one of validation datasets 188, which includes, among other things, a customer identifier (e.g., identifying a corresponding business customer of the financial institution), a temporal identifier (e.g., identifying a corresponding temporal interval), and an element of ground-truth data. Further, as described herein, each of elements of output data may be representative, for a corresponding business customer associated with a delinquency event involving a credit product, of a predicted likelihood that of an occurrence of a default event involving the corresponding business customer and the credit product during a future temporal interval, e.g., the target interval Δt_{target} separated from the corresponding temporal interval by buffer interval Δt_{buffer}, as described herein. In some instances, the predicted likelihood may be represented by a numerical value ranging from zero (e.g., indicative of a minimal predicted likelihood) to unity (e.g., indicative of a maximum predicted likelihood).

Executed adaptive training and validation module 182 may perform operations that compute a value of one or more metrics that characterize a predictive capability, and an accuracy, of the trained, gradient-boosted, decision-tree process based on the generated elements of output data and corresponding ones of validation datasets 188. The computed metrics may include, but are not limited to, one or more recall-based values for the trained, gradient-boosted, decision-tree process (e.g., “recall@5,” “recall@10,” “recall@20,” etc.), and additionally, or alternatively, one or more precision-based values for the trained, gradient-boosted, decision-tree process. Further, in some examples, the computed metrics may include a computed value of an area under curve (AUC) for a precision-recall (PR) curve associated with the trained, gradient-boosted, decision-tree process, and additional, or alternatively, computed value of an AUC for a receiver operating characteristic (ROC) curve associated with the trained, gradient-boosted, decision-tree process. The disclosed embodiments are, however, not limited to these exemplary computed metric values, and in other instances, executed adaptive training and validation module 182 may compute a value of any additional, or alternate, metric appropriate to validation datasets 188, the elements of ground-truth data, or the trained, machine-learning or artificial-intelligence process (e.g., the trained, gradient-boosted, decision-tree process)

In some examples, executed adaptive training and validation module 182 may also perform operations that determine whether all, or a selected portion of, the computed metric values satisfy one or more threshold conditions for a deployment of the trained, machine-learning or artificial-intelligence process and a real-time application to elements of customer profile, account, transaction, delinquency, aggregated industry, or credit-bureau data, as described herein. For instance, the one or more threshold conditions may specify one or more predetermined threshold values for the trained, gradient-boosted, decision-tree process, such as, but not limited to, a predetermined threshold value for the computed recall-based values, a predetermined threshold value for the computed precision-based values, and/or a predetermined threshold value for the computed AUC values. In some examples, executed adaptive training and validation module 182 that establish whether one, or more, of the computed recall-based values, the computed precision-based values, or the computed AUC values exceed, or fall below, a corresponding one of the predetermined threshold values and as such, whether the trained, machine-learning or artificial-intelligence process satisfies the one or more threshold requirements for deployment.

If, for example, executed adaptive training and validation module 182 were to establish that one, or more, of the computed metric values fail to satisfy at least one of the threshold requirements, Fl computing system 130 may establish that the trained, machine-learning or artificial-intelligence process is insufficiently accurate for deployment and a real-time application to the elements of customer profile, account, transaction, delinquency, aggregated industry, or credit-bureau data described herein. Executed adaptive training and validation module 182 may perform operations (not illustrated in FIG. 1B) that transmit data indicative of the established inaccuracy to executed training input module 176, which may perform any of the exemplary processes described herein to generate one or more additional training datasets and to provision those additional training datasets to executed adaptive training and validation module 182. In some instances, executed adaptive training and validation module 182 may receive the additional training datasets. Additionally, executed adaptive training and validation module 182 may perform any of the exemplary processes described herein to train further the machine-learning or artificial-intelligence process against the elements of training data included within each of the additional training datasets.

Alternatively, if executed adaptive training and validation module 182 were to establish that each computed metric value satisfies threshold requirements, Fl computing system 130 may deem the machine-learning or artificial-intelligence process trained and ready for deployment and real-time application to the elements of customer profile, account, transaction, delinquency, aggregated industry, or credit bureau data described herein. In some instances, executed adaptive training and validation module 182 may generate trained process data 190 that includes the process parameters of the trained, gradient-boosted, decision-tree process, such as, but not limited to, each of the candidate process parameters specified within candidate parameter data 184. Further, executed adaptive training and validation module 182 may also generate process input data 192, which characterizes a composition of an input dataset for the trained, machine-learning or artificial-intelligence process and identifies each of the discrete data elements within the input data set, along with a sequence or position of these elements within the input data set (e.g., as specified within candidate input data 186). As illustrated in FIG. 1C, executed adaptive training and validation module 182 may perform operations that store trained process data 190 and process input data 192 within the one or more tangible, non-transitory memories of Fl computing system 130, such as consolidated data store 144.

B. Exemplary Processes for Predicting Occurrences of Future Events using Trained, Artificial-Intelligence Processes and Normalized Feature Data

In some examples, one or more computing systems associated with or operated by a financial institution, such as one or more of the distributed components of Fl computing system 130, may perform operations that adaptively train a machine-learning or artificial-intelligence process to predict, at a temporal prediction point coinciding with, or disposed subsequent to, an occurrence of a delinquency event involving a business customer of the financial institution and a corresponding credit product, a likelihood of an occurrence of a default event involving that business customer of the financial institution and the corresponding credit product during a future temporal interval using training data associated with a first prior temporal interval, and using validation data associated with a second, and distinct, prior temporal interval As described herein, the delinquency event involving the business customer and the credit product may occur when the business customer fails to submit a scheduled payment associated with the credit product (e.g., when that scheduled payment becomes “past due”), and the temporal prediction point may be disposed within a predetermined first threshold pendency prior subsequent to the occurrence of the initiation event, such as, but not limited to, the thirty-day period described herein. Further, the default event involving the business customer and the credit product may occur when the scheduled payment remains delinquent for at least a second threshold duration, such as, but not limited to, sixty-day period described herein, and the future temporal interval may correspond to a target interval of eight months (e.g., target temporal interval Δt_{target} of FIG. 1E), which may be separated from the temporal prediction point by a one-month buffer interval (e.g., buffer interval Δt_{buffer} of FIG. 1E).

Further, the distributed components of Fl computing system 130 may also perform any of the exemplary processes described herein to generate input datasets associated with a selected subset of the business customers of the financial institution, and to apply the trained machine-learning or artificial-intelligence process, such as the trained, gradient-boosted, decision-tree process described herein, to each of the input datasets at a temporal prediction point. By way of example, the selected subset may include one or more of the business customers associated with a pending delinquency event involving a credit product issued by the financial institution (e.g., one of the unsecured credit products described herein, etc.) and characterized by a pendency period that fails to exceed the first threshold duration, e.g., thirty calendar days, as described herein. Based on the application of the trained machine-learning or artificial-intelligence process to each of the input datasets, the distributed components of Fl computing system 130 may perform any of the exemplary processes described herein to generate corresponding elements of output data, each of which may indicate of a predicted likelihood of an occurrence of a delinquency event involving a corresponding one of the selected subset business customers and a corresponding credit product during a future temporal interval, such as, but not limited to, an eight-month interval disposed between one and nine months subsequent to the temporal prediction point. As described herein, each of the generated elements of output data may include a numerical value (e.g., ranging from zero to unity) indicative of a predicted likelihood that the corresponding business customer will be involved in the default event during the future temporal interval (e.g., with a score of zero being indicative of a predicted non-occurrence of the default event during the predetermined time period, and with a score of unity being indicative of a predicted occurrence of the default event during the predetermined time period).

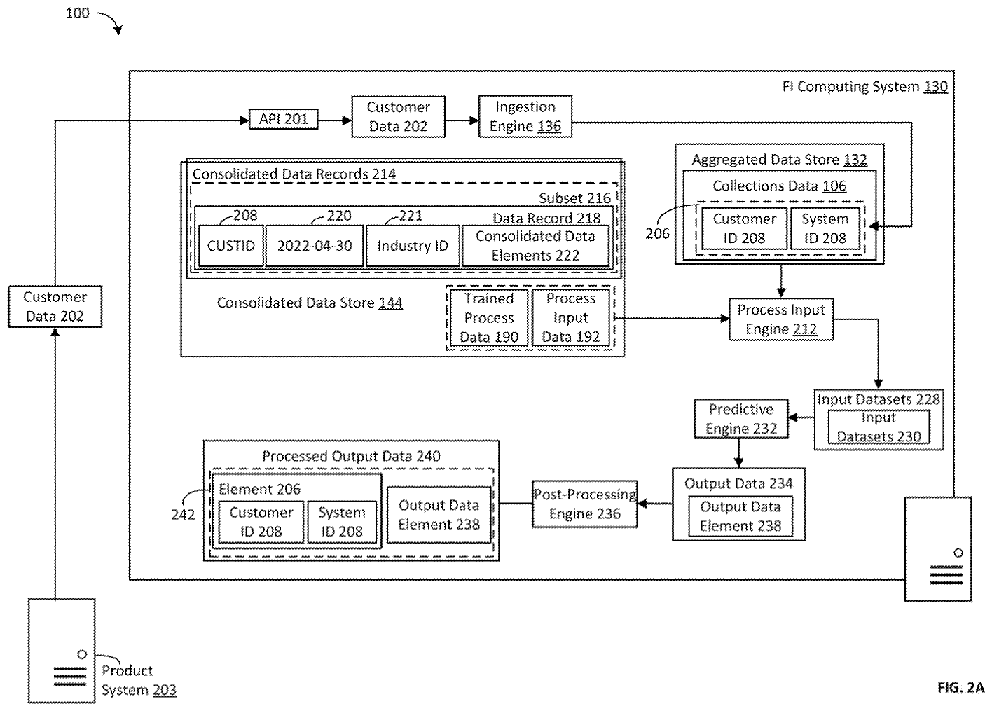

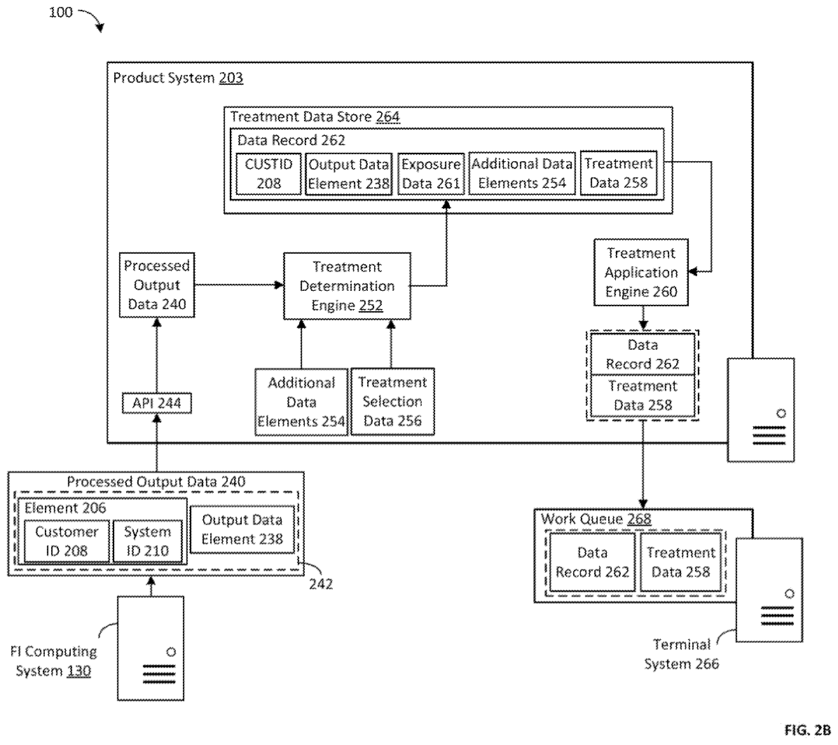

Referring to FIG. 2A, aggregated data store 132 of Fl computing system 130 may maintain one or more elements of customer data 202. In some instances, each of the one or more elements of customer data 202 may be associated with a business customer of the financial institution that holds a credit product issued by the financial institution (e.g., one or more of the unsecured credit products described herein) and further, that is associated with a pending delinquency event involving that credit product and characterized by a pendency period that fails to exceed a first threshold duration, such as the thirty-day period described herein. Fl computing system 130 may, for example, receive all, or a selected portion, of the elements of customer data 202 from one or more additional computing systems operated by, or associated with the financial institution, such as, but not limited to, a product system 203 associated with the now-delinquent credit product.

In some instances, each of the additional computing systems, including product system 203, may represent a computing system that includes one or more servers and tangible, non-transitory memories storing executable code and application modules. Further, the one or more servers may each include one or more processors (such as a central processing unit (CPU)), which may be configured to execute portions of the stored code or application modules to perform operations consistent with the disclosed embodiments. Each of the additional computing systems, including product system 203, may also include a communications interface, such as one or more wireless transceivers, coupled to the one or more processors for accommodating wired or wireless internet communication with other computing systems and devices operating within environment 100. In some instances, each of the additional computing systems, including product system 203, may be incorporated into a respective, discrete computing system, although in other instances, one or more of the additional computing systems, such as product system 203, may correspond to a distributed computing system having a plurality of interconnected, computing components distributed across an appropriate computing network, such as communications network 120 of FIG. 1A, or to a publicly accessible, distributed or cloud-based computing cluster, such as a computing cluster maintained by Microsoft Azure™, Amazon Web Services™, Google Cloud™, or another third-party provider.

Referring back to FIG. 2A, an application program executed by the one or more processors of product system 203 may transmit portions of customer data 202 across communications network 120 to Fl computing system 130. In some instances, the executed application program may cause product system 203 to transmit the portions of customer data 202 across communications network 120 to Fl computing system 130 in accordance with a predetermined schedule (e.g., at a predetermined time on a monthly basis (e.g., 8:00 a.m. on the first business day of each month), at predetermined time on a daily basis, etc.) and additionally, or alternatively, on a continuous streaming basis. The transmitted portions may be encrypted using a corresponding encryption key, such as a public cryptographic key associated with Fl computing system 130, and a programmatic interface established and maintained by Fl computing system 130, such as application programming interface (API) 201, may receive the portions of customer data 202 from product system 203.

API201 may, for example, route each of the elements of customer data 202 to executed data ingestion engine 136, which may perform operations that store the elements of customer data 202 within one or more tangible, non-transitory memories of Fl computing system 130, such as within aggregated data store 132. In some instances, and as described herein, the received elements of customer data 202 may be encrypted, and executed data ingestion engine 136 may perform operations that decrypt each of the encrypted elements of customer data 202 using a corresponding decryption key (e.g., a private cryptographic key associated with Fl computing system 130) prior to storage within aggregated data store 132. Further, although not illustrated in FIG. 2, aggregated data store 132 may also store one or more additional elements of customer data identifying business customers of the financial institution that hold corresponding ones of the unsecured credit products, and executed data ingestion engine 136 may perform one or more synchronization operation that merge the received elements of customer data 202 with the previously stored elements of customer data, and that eliminate any duplicate elements existing among the received elements of customer data 202 with the previously stored elements of customer data (e.g., through an invocation of an appropriate Java-based SQL “merge” command).

As described herein, each of the elements of customer data 202 may be associated with, and include a unique identifier of, a business customer of the financial institution, and Fl computing system 130 may receive each of the elements of customer data 202 from a corresponding one of the additional computing systems, such as product system 203. For example, as illustrated in FIG. 2, element 206 of customer data 202, which may be associated with a particular one of the business customers and received from product system 203, may include a customer identifier 208 assigned to the particular business customer by Fl computing system 130 (e.g., an alphanumeric character string, etc.), and a system identifier 210 associated with product system 203 (e.g., an Internet Protocol (IP) address, a media access control (MAC) address, etc.). Further, although not illustrated in FIG. 2, each additional, or alternate, element of customer data 202 may be associated with an additional business customer of the financial institution that holds an unsecured credit product and received from a corresponding one of the additional computing systems, and may include a customer identifier associated with that additional business customer and a system identifier associated with the corresponding one of the issuer systems.

As described herein, Fl computing system 130 may perform any of the exemplary processes described herein to generate an input dataset associated with each of the business customers identified by the discrete elements of customer data 202, and to apply a trained, machine-learning or artificial-intelligence process (e.g., the trained, gradient-boosted, decision-tree process described herein) to each of the input datasets, in accordance with a predetermined temporal schedule (e.g., at a predetermined day or time on a monthly basis, etc.) or in response to a detection of a triggering event. By way of example, the triggering event may correspond to a detected change in a composition of the elements of customer data 202 maintained within aggregated data store (e.g., to an ingestion of additional elements of customer data 202, etc.) or to a receipt of an explicit request received from product system 203.

In some instances, and in accordance with the predetermined temporal schedule (or in response to the detection of the triggering event), a process input engine 212 executed by Fl computing system 130 may perform operations that access the elements of customer data 202 maintained within aggregated data store 132, and that obtain the customer identifier maintained within a corresponding one of the accessed elements of customer data 202. For example, as illustrated in FIG. 2, executed process input engine 212 may access element 206 of customer data 202 (e.g., as maintained within aggregated data store 132) and obtain customer identifier 208, which includes, but is not limited to, the alphanumeric character string assigned to the particular business customer of the financial institution (e.g., one of customer identifiers 146 and 156 of FIGS. 1A and 1B, as described herein).

Executed process input engine 212 may also access consolidated data store 144, and perform operations that identify, within consolidated data records 214, a subset 216 of consolidated data records that include customer identifier 208 and as such, are associated with the particular business customer of the financial institution identified by element 206 of customer data 202. As described herein, each of consolidated data records 214 may be associated with a business customer of the financial institution, and may characterize that business customer, the interaction of that business customer with the financial institution and with other financial institutions, and any associated delinquency or default events involving that business customer during a corresponding temporal interval. For example, and as described herein, each of consolidated data records 214 may include a corresponding customer identifier (e.g., an alphanumeric character string assigned to a corresponding business customer), a corresponding temporal identifier (e.g., that identifies the corresponding temporal interval), a corresponding industry identifier associated with the particular business customer (e.g., a corresponding SIC code or MCC), and one or more elements of consolidated data associated with the corresponding business customer. Examples of these consolidated data elements may include, but are not limited to, elements customer profile data, account data, delinquency data, or credit-bureau data, which may be ingested, processed, aggregated, or filtered by FI computing system 130 using any of the exemplary processes described herein. Further, each of consolidated data records 214 may also include elements of industry data characterizing other business customers associated with the industry identifier.

In some instances, and as illustrated in FIG. 2A, each data record within subset 216 may include customer identifier 208 and as such, may be associated with the particular business customer identified by element 206 of customer data 202. By way of example, data record 218 of subset 216 may include customer identifier 208, a corresponding temporal identifier 220 (e.g., “2022-4-30,” indicating a temporal interval spanning Apr. 1, 2022, through Apr. 30, 2022), and a corresponding industry identifier 221, which identify and characterize the particular business customer during the temporal interval spanning Apr. 1, 2022, through Apr. 30, 2022, and industry data elements 223, which include the aggregated or averaged transaction or account parameters values characterizing other business customers associated with industry identifier 221.

Executed process input engine 212 may also perform operations that obtain, from consolidated data store 144, elements of process input data 192 characterize a composition of an input dataset for the trained, gradient-boosted, decision-tree process. In some instances, executed process input engine 212 may parse process input data 192 to obtain the composition of the input dataset, which not only identifies the elements of customer-specific data included within each input data set dataset (e.g., input feature values, as described herein), but also a specified sequence or position of these input feature values within the input dataset. Examples of these input feature values include, but are not limited to, one or more of the candidate feature values extracted, obtained, computed, determined, or derived by executed training input module 176 and packaged into corresponding potions of training datasets 180 using any of the exemplary processes described herein.

In some instances, and based on the parsed portions of process input data 192, executed process input engine 212 may perform any of the exemplary processes described herein to identify, and obtain or extract, one or more of the input feature values from one or more of data records maintained within subset 216 of consolidated data records 214 and associated with temporal intervals disposed within the extraction interval Δt_{extract}as described herein. Executed process input engine 212 may perform operations that package the obtained, or extracted, input feature values within a corresponding one of input datasets 228, such as input dataset 230 associated with the particular customer identified by element 206 of customer data 202, in accordance with their respective, specified sequences or positions. Further, in some examples, and based on the parsed portions of process input data 192, executed process input engine 212 may perform any of the exemplary processes described herein to compute, determine, or derive one or more of the input features values based on the elements of data extracted or obtained from the additional ones of the consolidated data records. As described herein, the particular business customer may also be associated with a particular industry type or class or a particular subdivision of the industry type or class, and the computed, determined, or derived input features values may also include one or more “normalized” feature values that characterize an account-based, transactional, or financial behavior of the corresponding business customer relative to comparable account-based, transactional, or financial behavior of other business customers that operate within the particular industry type or class, or the particular subdivision of the industry type or class, associated with the particular business customer (e.g., that share a common SIC code or MCC with the corresponding business customer). Executed process input engine 212 may perform operations that package each of the computed, determined, or derived input feature values (and in some instances, one or more of the normalized feature values) into portions of input dataset 230 in accordance with their respective, specified sequences or positions.

Through an implementation of these exemplary processes, executed process input engine 212 may populate an input dataset associated with the particular business customer identified by element 206 of customer data 202, such as input dataset 230 of input datasets 228, with input feature values obtained or extracted from, or computed, determined or derived from element of data within, the data records of subset 216. Further, in some instances, executed process input engine 212 may also perform any of the exemplary processes described herein to generate, and populate with input feature values, an additional one of input datasets 228 for each of the additional, or alternate, business customers of the financial institution (e.g., which are associated with additional, or alternate, elements of customer data 202). Executed process input engine 212 may package each of the customer-specific input datasets within input datasets 228, and executed process input engine 212 may provide input datasets 228 as an input to a predictive engine 232 executed by the one or more processors of Fl computing system 130.

As illustrated in FIG. 2A, executed predictive engine 232 may perform operations that obtain, from consolidated data store 144, elements of trained process data 190 that include a value of one or more process parameters of the trained, machine-learning or artificial-intelligence process (e.g., the trained gradient-boosted, decision-tree process described herein). For example, and as described herein, the process parameters included within trained process data 190 may include, but are not limited to, a learning rate associated with the trained, gradient-boosted, decision-tree process, a number of discrete decision trees included within the trained, gradient-boosted, decision-tree process (e.g., the “n_estimator” for the trained, gradient-boosted, decision-tree process), a tree depth characterizing a depth of each of the discrete decision trees included within the trained, gradient-boosted, decision-tree process, a minimum number of observations in terminal nodes of the decision trees, and/or values of one or more hyperparameters that reduce potential model overfitting (e.g., regularization of pseudo-regularization hyperparameters).

In some instances, and based the values of the process parameters maintained within trained process data 190, executed predictive engine 232 may perform operations that apply the trained, machine-learning or artificial-intelligence process to each of input datasets 228, including input dataset 230 associated with the particular business customer associated with element 206 of customer data 202. Based on the application of the trained, machine-learning or artificial-intelligence process to each of input datasets 228, executed predictive engine 232 may perform operations that, for each of input datasets 228, generate an element of output data indicative of a predicted likelihood that a corresponding one of the business customers will be associated with a default event involving a delinquent credit product during the future temporal interval (e.g., the target interval Δt_{target}, described herein).

By way of example, and in accordance with the values of the process parameters maintained within trained process data 190, executed predictive engine 232 may perform operations that establish a plurality of nodes and a plurality of decision trees for the trained, gradient-boosted, decision-tree process, each of which receive, as inputs (e.g., “ingest”), corresponding elements of input datasets 228. Further, and based on the execution of predictive engine 232, and on the ingestion of input datasets 228 by the established nodes and decision trees of the trained, gradient-boosted, decision-tree process, Fl computing system 130 may perform operations that apply the trained, gradient-boosted, decision-tree process to each of the input datasets of input datasets 228, including input dataset 230, and that generate an element of output data 234 associated with a corresponding one of input datasets 228, and as such, a corresponding one of the business customers identified by the elements of customer data 202.

As described herein, each of the generated elements of output data 234 may include a numerical value indicative of a predicted likelihood that the corresponding one of the business customers will be associated with the default event involving the delinquent credit product during the future temporal interval (e.g., the target interval Δt_{target}, described herein). In some examples, the numerical value within each of the elements of output data 234 may range from zero (e.g., indicative of a minimal predicted likelihood) to unity (e.g., indicative of a maximum predicted likelihood). Further, in some examples, when predictive engine 232 ingests one or more of input datasets 228 that include “normalized” input feature values associated with corresponding ones of the business customers, a magnitude of the numerical value maintained within corresponding elements of output data 234 may reflect whether an account-based, transactional, or financial behavior of the corresponding business customer is comparable to, or reflects a deviation, from the account-based, transactional, or financial behaviors of similar business customer of the financial institution (e.g., that share a common SIC code or MCC with the corresponding customer).

As illustrated in FIG. 2A, executed predictive engine 232 may provide the generated elements of output data 234 (e.g., either alone, or in conjunction with corresponding ones of input datasets 228) as an input to a post-processing engine 236 executed by the one or more processors of Fl computing system 130. In some instances, and upon receipt of the generated elements of output data 234 (e.g., and additionally, or alternatively, the corresponding ones of input datasets 228), executed post-processing engine 236 may perform operations that access the elements of customer data 202 maintained within aggregated data store 132, and associate each of the elements of customer data 202 (e.g., that identify a corresponding one of the business customers of the financial institution that hold the credit product and are involved in the corresponding delinquency event) with a corresponding one of the elements of output data 234 (e.g., that include numerical values indicative of the predicted likelihood that corresponding ones of the business customers will be involved in a default event during the future temporal interval).

By way of example, output data element 238 of output data 234 may be associated with the particular business customer that associated with element 206 of customer data 202. As described herein, particular business customer may hold a delinquent credit product issued by the financial institution, such as a delinquent, unsecured line-of-credit, and output data element 238 may include a numerical value of 0.84, which indicates a predicted, 84% likelihood that particular business customer will be associated with an occurrence of a default event involving a delinquent, unsecured line-of-credit during the future temporal interval. Executed post-processing engine 236 may, in some instances, associate element 206 of customer data 202 with output data element 238, and may perform any of these exemplary processes to associate each additional, or alternate, one of the elements of output data 234 with a corresponding one of the elements of customer data 202.

Further, and in some instances, executed post-processing engine 236 may perform operations that sort the associated elements of customer data 202 and output data 234 based on the corresponding numerical values (e.g., which indicate the predicted likelihood that corresponding ones of the business customer will be involved in a default event during the future temporal interval). In some instances, executed post-processing engine 236 may rank the associated elements of customer data 202 and output data 234 based on a magnitude of the corresponding numerical values (e.g., in descending order from unity to zero), and may establish that a subset of the ranked elements of customer data 202 and output data 234 characterizing business customers associated with an elevated risk of default to the financial institution during the future temporal interval (e.g., a predetermined percentage, such as 3%, of those business customer characterized by the highest numerical values, or those business customers associated with a numerical value that exceeds a predetermined, threshold value).

By way of example, and based on the numerical value of 0.84 maintained within output data elements 238, executed post-processing engine 236 may establish that the particular business customer associated with element 206 of customer data 202 represents an elevated risk of default during the future temporal interval (e.g., based on the 84% likelihood of the default event involving the particular business customer and the delinquent credit product held by the particular business customer). In some instances, executed post-processing engine 236 may perform operations that package the subset of the associated elements of customer data 202 and output data 234, including element 206 and output data element 238 associated with the particular business customer, into corresponding portions of processed output data 240. For example, and for the particular business customer of the financial institution, processed output data 240 may include a corresponding element 242 that associates together element 206 of customer data 202 (which includes customer identifier 208 of the particular business customer) and output data element 238 of output data 234 (which specifies a numerical value of 0.84 for the particular business customer).

As illustrated in FIG. 2A, Fl computing system 130 may perform operations that transmit all, or a selected portion of, processed output data 240 to product system 203 and additionally, or alternatively, to other ones of the additional computing systems described herein. By way of example, Fl computing system 130 may obtain the system identifier included within each of the associated elements of customer data 202 and output data 234 within processed output data 240 (e.g., system identifier 210 maintained within sorted element 242 of processed output data 240), and based on the system identifiers, perform operations that transmit each of the elements of processed output data 240 across communications network 120 to a corresponding one of the additional computing systems, such as, but not limited to product system 203 associated with system identifier 210. Further, although not illustrated in FIG. 2, Fl computing system 130 may also encrypt all, or a selected portion of, processed output data 240 prior to transmission across communications network 120 using a corresponding encryption key, such as, but not limited to, a corresponding public cryptographic key associated with a corresponding one of the additional computing systems, such as a public cryptographic key of product system 203.

Referring to FIG. 2B, a programmatic interface associated with and maintained by product system 203, such as application programming interface (API) 244, may receive all, or a selected portion, of processed output data 240 from Fl computing system 130, and may route processed output data 240 to treatment determination engine 252 executed by the one or more processors of product system 203. In some instances, the elements of processed output data 240 may associate together elements of customer data 202 (e.g., that identify and characterize corresponding business customers of the financial institution) and elements of processed output data 234 (e.g., which include numerical values indicative of a predicted likelihood of an occurrence of a default event involving the corresponding business customers and delinquent credit products held by the corresponding business customers during a future temporal interval). By way of example, and as described herein, the elements of processed output data 240 may include the subset of the ranked elements of customer data 202 and output data 234 characterizing business customers associated with an elevated risk of default to the financial institution during the future temporal interval. For instance, elements 242 of processed output data 240 may include element 206 of customer data, which includes customer identifier 208 of the particular business customer described herein, and output data element 238 of output data 240, which specifies the predicted, 84% likelihood the particular business customer, and the corresponding delinquent financial product, will be involved in occurrence of a default invent during the future temporal interval.

In some instances, and upon execution by the one or more processors of product system 203, executed treatment determination engine 252 may parse each element of processed output data 240 (including element 242), and perform operations that, based on the parsed elements of processed output data 240, identify and apply one or more treatment or remediation processes to corresponding ones of the business customers, and to corresponding ones of the delinquent credit products held by these business customers, in accordance with the likelihood of future occurrences of default events involving the business customers and delinquent credit products. As described herein, each of the business customers may be associated with pending delinquency event involving a corresponding one of the delinquent financial products (e.g., characterized by a pendency period less that the first threshold duration of thirty calendar days), and a targeted application of the one or more treatment or remediation processes to each, or a selected subset, of the business customers during the pending delinquency events, may facilitate a resolution of the pending delinquency events prior to an occurrence of any default event involving the corresponding business customer and corresponding delinquent credit product.

By way of example, executed treatment determination engine 252 may access element 242 of processed output data 240, which associates together customer identifier 208, system identifier 210 and output data element 238 (a numerical value of 0.84 indicative of the predicted likelihood that an occurrence of a default event involving the particular business customer and the credit product during a future temporal interval). As described herein, customer identifier 208 may be associated with the particular business customer that holds an unsecured line-of-credit issued by the financial institution (e.g., the delinquent credit product), which may be involved in a pending delinquency event during the temporal interval between Apr. 1, 2022, and Apr. 30, 2022(e.g., associated with temporal identifier 220 of FIG. 2A).

Executed treatment determination engine 252 may that obtain customer identifier 208 and output data element 238 from element 242 of processed output data 240, and may parse output data element 238 and obtain the numerical value associated the particular business customer from output data element 238. As described herein, the numerical value may correspond to 0.84, which indicates a predicted, 84% likelihood that the particular business customer and the delinquent, unsecured line-of-credit will be involved in a default event during the future temporal interval, e.g., an eight-month temporal interval disposed between one and nine months the temporal prediction point described herein. Furthermore, and based on customer identifier 208, executed treatment determination engine 252 may obtain additional data elements 254 that characterize the particular business customer, the delinquent, unsecured line-of-credit, and interactions between the particular business customer and with other financial products provisioned by the financial institution from one or more tangible, non-transitory memories of product system 203.

By way of example, and based on additional data elements 254 and on the obtained numerical value (e.g., 0.84), executed treatment determination engine 252 may compute a value of one or more metrics characterizing the exposure of the financial institution to risk associated with the predicted likelihood of the future default event involving the particular business customer and the delinquent, unsecured line-of-credit. Examples of the metrics include, but are not limited to, a credit exposure of the financial institution due to the predicted likelihood of the future occurrence of the default event (e.g., a total outstanding balance (principal, interest, and fees) associated with the delinquent, unsecured line-of-credit), a remaining amount of credit available to the particular business customer via the delinquent, unsecured line-of-credit, a credit exposure of the financial institution associated with additional, or alternate, credit products held by the particular business customer (e.g., a total balance and/or a total amount of credit extended to the particular business customer across the additional, or alternate, credit products), or a value of liquid assets available to the financial institution for offsetting potential losses (e.g., an available balance of funds within one or more demand deposit accounts, such as checking or savings accounts, etc.).

In some instances, based on the obtained numerical value and the one or more metric values, executed treatment determination engine 252 may perform operations that compute an exposure score indicative of a level of risk posed to the financial institution by the predicted, 84% likelihood of occurrence of the future default event involving the particular business customer and the delinquent, unsecured line-of-credit. The exposure score may range from zero to unity, with an exposure score of zero indicating a minimum risk, and with an exposure score of unity indicating a maximum risk. Further, executed treatment determination engine 252 may compute the exposure score as an arithmetic mean, a geometric mean, or a weighted average of a plurality of inputs that characterize, among other things, the obtained numerical value (e.g., 0.84) and one or more of the computed metric values, and the computed exposure score for the particular business customer may be adjusted based on, among other things, a scope or a duration of an existing relationship with between the particular business customer and the financial institution.

Further, and based on the computed exposure score, executed treatment determination engine 252 may determine one or more remediation processes or treatments that, if applied to the pending delinquency event involving the particular business customer and the delinquent, unsecured line-of-credit, may resolve that pending delinquency event without an occurrence of the predicted default event. In some examples, executed treatment determination engine 252 may obtain, from the one or more tangible, non-transitory memories of product system 203, elements of treatment selection data 256 that, among other things, identify one or more y candidate remediation processes or treatments available for application to the pending delinquency event involving the particular business customer and the delinquent, unsecured line-of-credit, and further, that specify criteria for selecting one, or more, of the candidate remediation processes or treatments for application to the pending delinquency event based on the computed exposure score and/or certain factors specific to the particular business customer, the delinquent, unsecured line-of-credit, or the pending delinquency event.

As described herein, the candidate remediation processes or treatments may include, but are not limited to, generating and provisioning, to the corresponding business customer, physical or electronic correspondence regarding the corresponding occurrence of the delinquency event (e.g., a physical letter, an email, a text-message, or an in-app notification, etc.), or initiating voice-based communications with the corresponding business customer (e.g., via a pre-recorded message delivered by telephone, via a call manually generated by a representative of the financial institution). Further, in some instances, the candidate remediation processes or treatments may also include, among other things, withdrawing funds from one or more accounts of the corresponding business customer based on a right of offset maintained by the financial institution, or performing operations that recover all, or a portion, of the past-due balance through interactions with a third-party collections agency. In other instances, the candidate remediation processes or treatments may include a deferral of any treatment of the delinquent business customer or the delinquent financial product or instrument. In various implementations, the candidate remediation process or treatments may include modify one or more of the terms and conditions of the extended credit based on an evolution in the relationships between the financial institutions and the business customers, and based on the business customer's use, or misuse, of various financial or credit instruments issued by these financial institutions.

For example, for an exposure score that indicates the predicted occurrence of the default event involving the particular business customer and the delinquent, unsecured line-of-credit poses a low risk to the financial institution (e.g., a score of between zero and 0.25) the elements of treatment selection data 256 may identify, as appropriate to the low risk level, candidate remediation processes or treatments that include, but are not limited to, provisioning of electronic correspondence to the particular business customer regarding the pending delinquency event involving the credit-card account (an email, a text-message, or an in-app notification provisioned to a device of the particular business customer, etc.) or an initiation of a pre-recorded, voice-based communication with the device.

In other examples, for an exposure score that indicates the predicted occurrence of the default event involving the particular business customer and the delinquent, unsecured line-of-credit poses for a moderate risk to the financial institution (e.g., a numerical and exposure score between 0.25 and 0.75), elements of treatment selection data 256 may identify, as appropriate to the moderate risk level, candidate remediation processes or treatments that include, but are not limited to, a provisioning of electronic correspondence to the particular business customer regarding the pending delinquency event (an email, a text-message, or an in-app notification provisioned to a device of the particular business customer, etc.), a provisioning of physical correspondence to the particular business customer regarding the pending delinquency event (e.g., a delivery of a physical letter to a residence of the particular business customer, etc.), and an initiation, by the representative of the financial institution, of a voice-based communication with the device.

Further, for an exposure score that indicates the predicted occurrence of the default event involving the particular business customer and the delinquent, unsecured line-of-credit poses an elevated level of risk to the financial institution (e.g., a numerical value and exposure score in excess of 0.75), an application of remediation processes of treatments by the financial institution may be incapable of preventing the predicted occurrence of the default event. In some instances, the elements of treatment selection data 256 may identify, as appropriate to the elevated risk level, candidate remediation processes or treatments that allow the financial institution to recover all, or at least a portion, of the past-due balance, such as, but not limited to, withdrawing funds from one or more accounts of the particular business customer based on a right of offset maintained by the financial institution, or performing operations that recover all, or a portion, of the past-due balance through interactions with a third-party collections agency.

The disclosed exemplary embodiments are, however, not limited to these exemplary, risk-, customer-, or product-specified remediation processes or treatments. In other instances, the elements of treatment selection data 256 may include any additional, or alternate, candidate radiation processes or treatments appropriate to the business customers, the delinquent credit products, or the risk posed to the financial institution by future default events involving these business customers and delinquent credit products.

Referring back to FIG. 2B, executed treatment determination engine 252 may perform any of the exemplary processes described herein to compute an exposure score of 0.65 for the particular business customer and the delinquent, unsecured line-of-credit, e.g., associated with element 242 of processed output data 240 and the numerical value of 0.84. Based on the elements of treatment selection data 256, executed treatment determination engine 252 may establish that the predicted, 84% likelihood of the occurrence of the default event involving the particular business customer and the delinquent, unsecured line-of-credit during the future temporal interval poses a moderate risk to the financial institution, and may determine that the provisioning of physical correspondence to the particular business customer regarding the pending delinquency event and the initiation, by the representative of the financial institution, of a voice-based communication with the business customer's device, represent remediation processes or treatments appropriate to the moderate risk.

In some instances, executed treatment determination engine 252 may perform operations that package, into corresponding potions of treatment data 258, information identifying the selected remediation processes or treatments, such as, but not limited to, the provisioning of physical correspondence to the particular business customer regarding the pending delinquency event and the initiation, by the representative of the financial institution, of a voice-based communication with the device of the particular business customer. Executed treatment determination engine 252 may also perform operations that store customer identifier 208 of the particular business customer, output data element 238 (e.g., that includes the numerical value of 0.84 indicating the predicted likelihood of the future default event involving the particular business customer and the delinquent, unsecured line-of-credit), exposure data 261 (e.g., that include the computed exposure score of 0.65), and the elements of treatment data 258 within one or more of the tangible, non-transitory memories of product system 203 (e.g., within corresponding portions of data record 262 within treatment data store 264). Further, as illustrated in FIG. 2B, executed treatment determination engine 252 may also perform operations that store all, or a portion, of additional data elements 254 (e.g., that characterize the particular business customer, the delinquent, unsecured line-of-credit, and interactions between the particular business customer and with other financial products provisioned by the financial institution) within data record 262.

As illustrated in FIG. 2B, a treatment application engine 260 executed by the one or more processors of product system 203 may access data record 262 of treatment data store 264, which includes customer identifier 208 of the particular business customer, output data element 238 (e.g., that includes the numerical value of 0.84), exposure data 261 (e.g., that include the computed exposure score of 0.65), additional data elements 254, and treatment data 258. Executed treatment application engine 260 may parse the elements of treatment data 258, and may perform operations that implement the one or more remediation processes or treatments appropriate to the moderate risk level posed to the financial institution by the future occurrence of the default event involving the particular business customer and the delinquent, unsecured line-of-credit, e.g., the provisioning of physical correspondence to the particular business customer regarding the delinquent, unsecured line-of-credit and the initiation, by a representative of the financial institution, of a voice-based communication with the device of the particular business customer. By way of example, executed treatment application engine 260 may transmit treatment data 258 along with the portion of data record 285 across communications network 120 to a terminal system 263 operated by a representative of the financial institution. As illustrated in FIG. 2B, terminal system 263 may perform operations (e.g., via execution of stored software instructions by one or more corresponding processors) that store the portion of data record 285 and treatment data 258 within a portion of one or more tangible, non-transitory memories, such as within a portion of a work queue 266 of the representative, and terminal system 263 may perform operations that implement at least one of the remediation processes or treatments described herein that are appropriate to the moderate risk level (e.g., initiating a voice-based communication with the business customer's device, etc.).

Executed treatment determination engine 252 may also perform any of the exemplary processes described herein to access each additional, or alternate, element of processed output data 240, and to obtain a numerical value indicative of a predicted likelihood of an occurrence of a default event involving an additional business customer and the corresponding, delinquent credit product within during the future temporal interval. Based on at least the numerical values, executed treatment determination engine 252 may perform any of the exemplary processes described herein to determine that one or more of the candidate remediation processes or treatments are appropriate to a level of risk of financial loss associated with each of the pending delinquency events. Additionally, executed treatment determination engine 252 may perform any of the exemplary processes describe herein to generate elements of treatment data that identify and characterize the corresponding ones of the appropriate the candidate remediation processes or treatments and to store the generated elements of treatment data within an additional data record of treatment data store 264 (e.g., either alone or in conjunction with a corresponding customer identifier, a corresponding output data element, and a corresponding exposure store, etc.). Executed treatment application engine 260 may perform any of the exemplary processes described herein to access the elements of treatment data, and apply the appropriate the candidate remediation processes or treatments to corresponding ones of the pending delinquency events and the corresponding ones of the additional business customers.

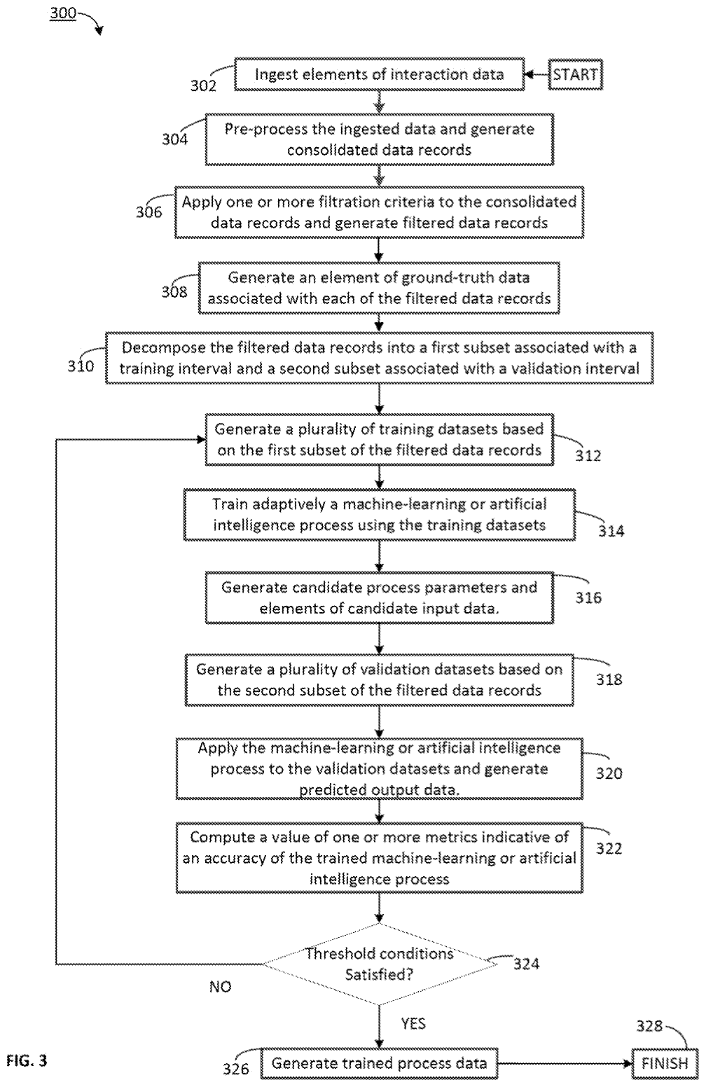

FIG. 3 is a flowchart of an exemplary process 300 for adaptively training a machine learning or artificial intelligence process to predict, at a temporal prediction point, a likelihood of an occurrence of a default event involving a business customer of the financial institution and a credit product during a targeted temporal interval disposed subsequent to an occurrence of a delinquency event involving that business customer and credit product using training datasets associated with a first prior temporal interval (e.g., a “training” interval), and using validation datasets associated with a second, and distinct, prior temporal interval (e.g., a “validation” interval). As described herein, the machine-learning or artificial-intelligence process may include an ensemble or decision-tree process, such as a gradient-boosted decision-tree process, e.g., an XGBoost process. In some instances, one or more computing systems, such as, but not limited to, one or more of the distributed components of Fl computing system 130, may perform one or of the steps of exemplary process 300, as described herein.

Referring to FIG. 3, Fl computing system 130 may perform any of the exemplary processes described herein to establish a secure, programmatic channel of communication with one or more source computing systems, such as source systems 102 of FIG. 1A, and to obtain, from the source computing systems, elements of interaction data that identify and characterize one or more business customers of the financial institution during corresponding temporal intervals (e.g., in step 302 of FIG. 3). The elements of interaction data may include, but are not limited to, one or more elements of customer profile, account, transaction, delinquency, aggregated industry and credit-bureau data associated with corresponding ones of the business customers, and Fl computing system 130 may also perform operations that store (or ingest) the obtained elements of internal and external interaction data within one or more accessible data repositories, such as aggregated data store 132 of FIG. 1A (e.g., also in step 302 of FIG. 3). In some instances, Fl computing system 130 may perform the exemplary processes described herein to obtain and ingest the elements of elements of interaction data in accordance with a predetermined temporal schedule (e.g., on a daily basis, a monthly basis, etc.), or a continuous streaming basis, across the secure, programmatic channel of communication.

Further, Fl computing system 130 may access the ingested elements of internal and external interaction data, and may perform any of the exemplary processes described herein to pre-process the ingested elements of interaction data (e.g., the elements of customer profile, account, transaction, delinquency, aggregated industry and credit-bureau data) and generate one or more consolidated data records (e.g., in step 304 of FIG. 3). As described herein, the Fl computing system 130 may store each of the consolidated data records within one or more accessible data repositories, such as consolidated data store 144 of FIG. 1A (e.g., also in step 304 of FIG. 3).

For example, and as described herein, each of the consolidated data records may include a customer identifier associated with a corresponding one of the business customer (e.g., an alphanumeric character string, etc.) and a temporal identifier that identifies a corresponding temporal interval associated with the ingestion of the interaction data. Further, and in addition to the customer and temporal identifiers, each of the consolidated data records may also include one or more consolidated elements of customer profile, account, transaction, delinquency, aggregated industry, or credit-bureau data that characterize the particular business customer during the corresponding temporal interval associated with the temporal identifier (e.g., consolidated data elements 152 and aggregated industry data elements 153 of data record 142A, etc.).

FI computing system 130 may also perform any of the exemplary processes described herein to filter each of the consolidated data records in accordance with one or more filtration criteria, and to generate corresponding filtered data records that are consistent with, and that satisfy, each of the one or more filtration criteria (e.g., in step 306 of FIG. 1). Fl computing system 130 may store each of the filtered data records within one or more accessible data repositories, such as consolidated data store 144 (e.g., also in step 306 of FIG. 3). In some instances, Fl computing system 130 may perform any of the exemplary processes that generate an element of ground-truth data associated with each of the filtered data records and that augment each of the filtered data records to incorporate the corresponding element of ground-truth data (e.g., in step 308 of FIG. 3). By way of example, and for a particular filtered data record associated with a corresponding business customer holding a delinquent credit product and a corresponding temporal interval, the corresponding element of ground-truth data may confirm an actual occurrence of a default event involving the delinquent credit product within target temporal interval Δt_{target} (e.g., the “positive” target described herein) or a non-occurrence of the default event involving the delinquent credit product within target temporal interval Δt_{target} (e.g., the “negative” target described herein).

In some instances, Fl computing system 130 may perform any of the exemplary processes described herein to decompose the filtered data records (including the corresponding elements of ground-truth data) into (i) a first subset of the filtered data records having temporal identifiers associated with a first prior temporal interval (e.g., the training interval Δt_{training}, as described herein) and (ii) a second subset of the filtered data records having temporal identifiers associated with a second prior temporal interval (e.g., the validation interval Δt_{validation}, as described herein), which may be separate, distinct, and disjoint from the first prior temporal interval (e.g., in step 310 of FIG. 3). By way of example, portions of the filtered data records within the first subset may be appropriate to train adaptively the machine-leaning or artificial process (e.g., the gradient-boosted decision process described herein during the training interval Δt_{training}, and portions of the consolidated records within the second subset may be appropriate to validating the trained gradient-boosted decision process during the validation interval Δt_{validation}.

In some instances, Fl computing system 130 may perform any of the exemplary processes described herein to generate a plurality of training datasets based on elements of data obtained, extracted, or derived from all or a selected portion of the first subset of the filtered data records (e.g., in step 312 of FIG. 3). By way of example, each of the plurality of training datasets may be associated with a corresponding one of the business customers of the financial institution and a corresponding temporal interval, and may include, among other things. a customer identifier associated with the corresponding business customer and a temporal identifier representative of the corresponding temporal interval. As described herein, each of the corresponding business customers may hold a delinquent credit product issued by the financial institution (e.g., one or more unsecured credit products described herein) and may be involving in a corresponding delinquent that occurred, or remained pending during, at least a portion of the corresponding temporal interval.

As described herein, each of the plurality of training datasets may also include elements of data (e.g., feature values) that characterize the corresponding business customer during the corresponding temporal interval, the corresponding delinquent credit product (e.g., the credit products described herein), the corresponding business customer's interaction with the financial institution or with other financial institutions during the corresponding temporal interval, a scope or duration of the corresponding delinquency event involving the delinquent credit product, and other business customers of the financial institution that are similar to, and operate in common industries, industry types, or industry sub-types, as the corresponding business customer. Further, as described herein, each of the plurality of training datasets may include an element of ground-truth data indicative of an actual occurrence, or non-occurrence, of a default event involving the corresponding business customer and the delinquent credit product during the future temporal interval, e.g., the eight-month target interval disposed between one and nine months subsequent to temporal prediction point t_{pred}).

Based on the plurality of training datasets, Fl computing system 130 may also perform any of the exemplary processes described herein to train adaptively the machine-learning or artificial-intelligence process (e.g., the gradient-boosted decision-tree process described herein) to predict, at a temporal prediction point, a likelihood of an occurrence of default event involving a business customer of a financial institution and a credit product issued by that financial institution during a predetermined, future temporal interval (e.g., in step 314 of FIG. 3). As described herein, the business customer may be associated with a delinquency event involving the credit product, and at the temporal prediction point, the delinquency event may be characterized by a pendency period that fails to exceed a first threshold duration, such as, but not limited to, thirty calendar days. Further, as described herein, the default event involving the business customer and the credit product may occur when the delinquency event remains pendant for a period that is equivalent to, or that exceeds, a second threshold duration, such as, but not limited to, sixty calendar days.

For example, and as described herein, Fl computing system 130 may perform operations that establish a plurality of nodes and a plurality of decision trees for the gradient-boosted, decision-tree process, which may ingest and process the elements of training data (e.g., the customer identifiers, the temporal identifiers, the feature values, etc.) maintained within each of the plurality of training datasets, and that adaptively train the gradient-boosted, decision-tree process against the elements of training data included within each of the plurality of the training datasets. In some instances, the distributed components of Fl computing system 130 may perform any of the exemplary processes described herein in parallel to establish the plurality of nodes and a plurality of decision trees for the gradient-boosted, decision-tree process, and to adaptively train the gradient-boosted, decision-tree process against the elements of training data included within each of the plurality of the training datasets. The parallel implementation of these exemplary adaptive training processes by the distributed components of Fl computing system 130 may, in some instances, be based on an implementation, across the distributed components, of one or more of the parallelized, fault-tolerant distributed computing and analytical protocols described herein.

Through the performance of these adaptive training processes, Fl computing system 130 may compute one or more candidate process parameters that characterize the trained machine-learning or artificial-intelligence process, such as, but not limited to, candidate process parameters for the trained, gradient-boosted, decision-tree process described herein (e.g., in step 316 of FIG. 3). By way of example, and for the trained, gradient-boosted, decision-tree process, the candidate process parameters included within candidate model data may include, but are not limited to, a learning rate associated with the trained, gradient-boosted, decision-tree process, a number of discrete decision trees included within the trained, gradient-boosted, decision-tree process (e.g., the “n_estimator” for the trained, gradient-boosted, decision-tree process), a tree depth characterizing a depth of each of the discrete decision trees included within the trained, gradient-boosted, decision-tree process, a minimum number of observations in terminal nodes of the decision trees, and/or values of one or more hyperparameters that reduce potential model overfitting (e.g., regularization of pseudo-regularization hyperparameters). Further, and based on the performance of these adaptive training processes, Fl computing system 130 may perform any of the exemplary processes described herein to generate candidate input data, which specifies a candidate composition of an input dataset for the trained machine-learning or artificial intelligence process, such as the trained, gradient-boosted, decision-tree process (e.g., also in step 316 of FIG. 3).

Further, Fl computing system 130 may perform any of the exemplary processes described herein to access the second subset of the consolidated data records, and to generate a plurality of validation subsets having compositions consistent with the candidate input data (e.g., in step 318 of FIG. 3). As described herein, each of the plurality of the validation datasets may be associated with a corresponding one of the business customers of the financial institution, and with a corresponding temporal interval within the validation interval Δt_{validation}, and may include a customer identifier associated with the corresponding one of the customers and a temporal identifier that identifies the corresponding temporal interval. Further, each of the plurality of the validation datasets may also include one or more feature values that are consistent with the candidate input data, associated with the corresponding one of the business customers, the delinquent credit products, and/or the corresponding delinquency events, and obtained, extracted, or derived from corresponding ones of the accessed second subset of the consolidated data records (e.g., during the corresponding extraction interval Δt_{extract}, as described herein). as described herein, each of the plurality of validation datasets may include an element of ground-truth data indicative of an actual occurrence, or non-occurrence, of a default event involving the corresponding business customer and the delinquent credit product during the future temporal interval, e.g., the eight-month target interval disposed between one and nine months subsequent to the temporal prediction point.

In some instances, Fl computing system 130 may perform any of the exemplary processes described herein to apply the trained machine-learning or artificial intelligence process (e.g., the trained, gradient-boosted, decision-tree process described herein) to respective ones of the validation datasets, and to generate corresponding elements of output data based on the application of the trained machine-learning or artificial intelligence process to the respective ones of the validation datasets (e.g., in step 320 of FIG. 3). As described herein, each of the generated elements of output data may be associated with a respective one of the validation datasets and as such, a corresponding one of the business customers of the financial institution. Further, each of the generated elements of output data may also include a numerical value (e.g., ranging from zero to unity) indicative of a predicted likelihood that the corresponding one of the business customers will experience, or will be involved in, a default event involving the delinquent credit product during the future temporal interval.

Further, and as described herein, the distributed components of Fl computing system 130 may perform any of the exemplary processes described herein in parallel to validate the trained machine-learning or artificial intelligence process (e.g., the trained, gradient-boosted, decision-tree process) based on the application of the trained machine-learning or artificial intelligence process (e.g., configured in accordance with the candidate process parameters) to each of the validation datasets. The parallel implementation of these exemplary adaptive validation processes by the distributed components of Fl computing system 130 may, in some instances, be based on an implementation, across the distributed components, of one or more of the parallelized, fault-tolerant distributed computing and analytical protocols described herein.

In some examples, Fl computing system 130 may perform any of the exemplary processes described herein to compute a value of one or more metrics that characterize a predictive capability, and an accuracy, of the trained machine-learning or artificial intelligence process (such as the trained, gradient-boosted, decision-tree process described herein) based on the generated elements of output data and corresponding ones of the validation datasets (e.g., in step 322 of FIG. 3), and to determine whether all, or a selected portion of, the computed metric values satisfy one or more threshold conditions for a deployment of the trained machine-learning or artificial intelligence process (e.g., in step 324 of FIG. 3). As described herein, and for the trained, gradient-boosted, decision-tree process, the computed metrics may include, but are not limited to, one or more recall-based values (e.g., “recall@5,” “recall@10,” “recall@20,” etc.), one or more precision-based values for the trained, gradient-boosted, decision-tree process, and additionally, or alternatively, a computed value of an area under curve (AUC) for a precision-recall (PR) curve or a computed value of an AUC for a receiver operating characteristic (ROC) curve associated with the trained, gradient-boosted, decision-tree process.

Further, and as described herein, the threshold requirements for the trained, gradient-boosted, decision-tree process may specify one or more predetermined threshold values, such as, but not limited to, a predetermined threshold value for the computed recall-based values, a predetermined threshold value for the computed precision-based values, and/or a predetermined threshold value for the computed AUC values. In some examples, Fl computing system 130 may perform any of the exemplary processes described herein to establish whether one, or more, of the computed recall-based values, the computed precision-based values, or the computed AUC values exceed, or fall below, a corresponding one of the predetermined threshold values and as such, whether the trained, gradient-boosted, decision-tree process satisfies the one or more threshold requirements for deployment.

If, for example, Fl computing system 130 were to establish that one, or more, of the computed metric values fail to satisfy at least one of the threshold requirements (e.g., step 324; NO), Fl computing system 130 may establish that the trained machine-learning or artificial-intelligence process (e.g., the trained, gradient-boosted, decision-tree process) is insufficiently accurate for deployment and a real-time application to the elements of customer profile, account, transaction, delinquency, aggregated industry or credit-bureau data described herein. Exemplary process 300 may, for example, pass back to step 312, and Fl computing system 130 may perform any of the exemplary processes described herein to generate additional training datasets based on the elements of the consolidated data records maintained within the first subset.

Alternatively, if Fl computing system 130 were to establish that each computed metric value satisfies threshold requirements (e.g., step 324; YES), Fl computing system 130 may deem the machine-learning or artificial intelligence process (e.g., the gradient-boosted, decision-tree process described herein) trained and ready for deployment and real-time application to the elements of customer profile, account, transaction, delinquency, aggregated industry or credit-bureau data described herein, and may perform any of the exemplary processes described herein to generate trained process data that includes the candidate process parameters and candidate input data associated with the of the trained machine-learning or artificial intelligence process (e.g., in step 326 of FIG. 3). Exemplary process 300 is then complete in step 328.

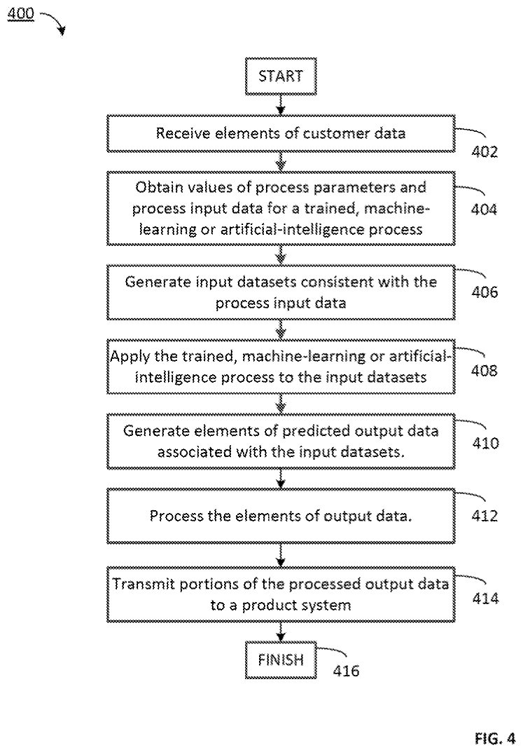

FIG. 4 is a flowchart of an exemplary process 400 for predicting likelihoods of future occurrences of default events involving one or more business customers of a financial institution based on an application of a trained machine-learning or artificial-intelligence process to customer-specific input datasets. As described herein, the machine-learning or artificial-intelligence process may include an ensemble or decision-tree process, such as a gradient-boosted decision-tree process (e.g., the XGBoost model), which may be trained adaptively to predict a likelihood of an occurrence of a default event involving a business customer and a delinquent credit product during a future temporal interval using training datasets associated with a first prior temporal interval (e.g., the training interval Δt_{training}, as described herein), and using validation datasets associated with a second, and distinct, prior temporal interval (e.g., the validation interval Δt_{validation}, as described herein). In some instances, one or more computing systems, such as, but not limited to, one or more of the distributed components of Fl computing system 130, may perform one or of the steps of exemplary process 400, as described herein.

Referring to FIG. 4, Fl computing system 130 may perform any of the exemplary processes described herein to receive elements of customer data that identify one or more business customers of the financial institution (e.g., in step 402 of FIG. 4). As described herein, each of the business customers may be associated with a corresponding delinquency event involving a credit product issued by the financial institution (e.g., one of the unsecured credit products described herein), and each of the corresponding delinquency events may characterized by a pendency period that fails to exceed a first threshold duration, such as, but not limited to, thirty calendar days.

For example, Fl computing system 130 may receive the elements of customer data from one or more additional computing systems associated with, or operated by, the financial institution (such as, but not limited to, product system 203), and in some instances, Fl computing system 130 may perform any of the exemplary processes described herein to store the obtained elements of customer data within a locally accessible data repository (e.g., within aggregated data store 132). Further, in some instances, Fl computing system 130 may also perform any of the exemplary processes described herein to synchronize and merge the obtained elements of customer data with one or more previously ingested elements of customer data maintained within the locally accessible data repository. In some instances, each of the elements of customer data may be associated with a corresponding one of the business customers, and may include a customer identifier associated with the corresponding one of the business customers (e.g., the alphanumeric character string, etc.) and a system identifier associated with a corresponding one of the additional computing systems (e.g., an IP or MAC address of product system 203, etc.).

Fl computing system 130 may perform any of the exemplary processes described herein to generate an input dataset associated with each of the business customers identified by the discrete elements of customer data 202, and to apply the trained, machine-learning or artificial-intelligence process described herein to each of the input datasets, in accordance with a predetermined temporal schedule (e.g., on a daily basis, a monthly basis, etc.), or in response to a detection of a triggering event. By way of example, and without limitation, the triggering event may correspond to a detected change in a composition of the elements of customer data 202 maintained within aggregated data store (e.g., to an ingestion of additional elements of customer data 202, etc.) or to a receipt of an explicit request received from product system 203).

For example, Fl computing system 130 may also perform any of the exemplary processes described herein to obtain a value of one or more process parameters that characterize the trained machine-learning or artificial-intelligence process (e.g., the trained, gradient-boosted, decision-tree process described herein) and elements of process input data that specify a composition of an input dataset for the trained machine-learning or artificial-intelligence process (e.g., in step 404 of FIG. 4). In some instances, and for the trained, gradient-boosted, decision-tree process described herein, the one or more process parameter values may include, but are not limited to, a learning rate associated with the trained, gradient-boosted, decision-tree process, a number of discrete decision trees included within the trained, gradient-boosted, decision-tree process (e.g., the “n_estimator” for the trained, gradient-boosted, decision-tree process), a tree depth characterizing a depth of each of the discrete decision trees included within the trained, gradient-boosted, decision-tree process, a minimum number of observations in terminal nodes of the decision trees, and/or values of one or more hyperparameters that reduce potential process overfitting (e.g., regularization of pseudo-regularization hyperparameters). Further, the elements of process input data may specify the composition of the input dataset for the trained, gradient-boosted, decision-tree process, which not only identifies the elements of customer-specific data included within each input data set dataset (e.g., input feature values, as described herein), but also a specified sequence or position of these input feature values within the input dataset.

Fl computing system 130 may access filtered data records associated with one or more of the business customers of the financial institution, and may perform any of the exemplary processes described herein to generate, for each of the one or more business customers, a customer-specific input dataset having a composition consistent with the elements of model input data (e.g., in step 406 of FIG. 4). Further, and based on the values of the one or more obtained process parameters, Fl computing system 130 may perform any of the exemplary processes described herein to apply the trained machine-learning or artificial-intelligence process (e.g., the trained, gradient-boosted, decision-tree process described herein) to each of the generated, customer-specific input datasets (e.g., in step 408 of FIG. 4), and to generate a customer-specific element of predicted output data associated with each of the customer-specific input datasets (e.g., in step 410 of FIG. 4).

For example, and based on the one or more obtained process parameters, Fl computing system 130 may perform operations, described herein, that establish a plurality of nodes and a plurality of decision trees for the trained, gradient-boosted, decision-tree process, each of which receive, as inputs (e.g., “ingest”), corresponding elements of the customer-specific input datasets. Based on the ingestion of the input datasets by the established nodes and decision trees of the trained, gradient-boosted, decision-tree process, Fl computing system 130 may perform operations that apply the trained, gradient-boosted, decision-tree process to each of the customer-specific input datasets and that generate the customer-specific elements of the output data associated with the customer-specific input datasets.

As described herein, each of the business customers identified within customer data 202 may be associated with a pending delinquency event involving a corresponding credit product issued by the financial institution, and each of the delinquency events may characterized by a pendency period that fails to exceed a first threshold duration, such as, but not limited to, thirty calendar days. In some instances, each of the customer-specific elements of output data may include a numerical value indicative of a predicted likelihood that a corresponding one of the business customers will be associated with a default event involving the corresponding credit product during the future temporal interval, e.g., an eight-month interval disposed between one and nine months subsequent to a temporal prediction point. Further, as described herein, the default event involving the corresponding business customer and the corresponding credit product may occur during the future temporal interval when the corresponding delinquency event remains pendant for a period that is equivalent to, or that exceeds, a second threshold duration, such as, but not limited to, sixty calendar days, and the numerical value within each of the customer-specific elements of output data may range from zero (e.g., indicative of a minimal predicted likelihood) to unity (e.g., indicative of a maximum predicted likelihood).

Fl computing system 130 may also perform any of the exemplary processes described herein to process the customer-specific elements of output data and, among other things, associate each of the customer-specific elements of output data with a corresponding element of the received customer data (e.g., in step 412 of FIG. 4). For example, in step 412, Fl computing system 130 may also perform any of the exemplary processes to rank the associated data records and customer-specific elements of output data based on magnitudes of the corresponding numerical values, which indicate the predicted likelihood that corresponding one of the business customers will be involved in a default event during the future temporal interval. Fl computing system 130 may perform any of the exemplary processes described herein to transmit all, or a selected portion of, the elements of processed output data across communications network 120 to one or more additional computing systems associated with the financial institution, such as, but not limited to, product system 203 (e.g., in step 414 of FIG. 4).

By way of example, and as described herein, product system 203 may receive the elements of processed output data from Fl computing system 130, and may perform any of the exemplary processes described herein to that parse each of the elements of sorted output data to obtain a customer identifier of a corresponding one of the business customer associated with a pending delinquency event involving a corresponding credit product, and to obtain a numerical value indicative of a predicted likelihood of an occurrence of a default event involving the corresponding business customer and the corresponding credit product during a future temporal interval. Based on the obtained numerical values, and on additional data characterizing the corresponding business customers, the corresponding credit products, or the pending delinquency events, product system 203 may perform any of the exemplary processes described herein to determine, for each of the business customers, one or more remediation processes or treatments that, if implemented during the pending delinquency event, may resolve that pending delinquency event prior to the predicted occurrence of the default event involving the corresponding credit product. Exemplary process 400 is then complete in step 416.

### C. Exemplary Hardware and Software Implementations

Examples of the subject matter and the functional operations described in this specification may be implemented in digital electronic circuitry, in tangibly-embodied computer software or firmware, in computer hardware, including the structures disclosed in this specification and their structural equivalents, or in combinations of one or more of them. Exemplary embodiments of the subject matter described in this specification, such as application programming interfaces (APIs) 134, 201, and 244, ingestion engine 136, pre-processing engine 140, filtration engine 151, training engine 172, training input module 176, adaptive training and validation module 182, process input engine 212, predictive engine 232, post-processing engine 236, treatment determination engine 252, and treatment application engine 260, may implemented as one or more computer programs, i.e., one or more modules of computer program instructions encoded on a tangible non-transitory program carrier for execution by, or to control the operation of, a data processing apparatus (or a computer system or a computing device).

Additionally, or alternatively, the program instructions may be encoded on an artificially generated propagated signal, such as a machine-generated electrical, optical, or electromagnetic signal that is generated to encode information for transmission to suitable receiver apparatus for execution by a data processing apparatus. The computer storage medium may be a machine-readable storage device, a machine-readable storage substrate, a random or serial access memory device, or a combination of one or more of them.

The terms “apparatus,” “device,” and “system” (e.g., the Fl computing system and the device described herein) refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system may also be or further include special purpose logic circuitry, such as an FPGA (field programmable gate array) or an ASIC (application-specific integrated circuit). The apparatus, device, or system may optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, may be written in any form of programming language, including compiled or interpreted languages, or declarative or procedural languages, and it may be deployed in any form, including as a stand-alone program or as a module, component, subroutine, or other unit suitable for use in a computing environment. A computer program may, but need not, correspond to a file in a file system. A program may be stored in a portion of a file that holds other programs or data, such as one or more scripts stored in a markup language document, in a single file dedicated to the program in question, or in multiple coordinated files, such as files that store one or more modules, sub-programs, or portions of code. A computer program may be deployed to be executed on one computer or on multiple computers that are located at one site or distributed across multiple sites and interconnected by a communication network.

The processes and logic flows described in this specification may be performed by one or more programmable computers executing one or more computer programs to perform functions by operating on input data and generating output. The processes and logic flows may also be performed by, and apparatus may also be implemented as, special purpose logic circuitry, such as an FPGA (field programmable gate array), an ASIC (application-specific integrated circuit), one or more processors, or any other suitable logic.

Computers suitable for the execution of a computer program include, by way of example, general or special purpose microprocessors or both, or any other kind of central processing unit. Generally, a CPU will receive instructions and data from a read-only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer may be embedded in another device, such as a mobile telephone, a personal digital assistant (PDA), a mobile audio or video player, a game console, a Global Positioning System (GPS) receiver, or a portable storage device, such as a universal serial bus (USB) flash drive.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory may be supplemented by, or incorporated in, special purpose logic circuitry.

To provide for interaction with a user (e.g., the business customer or employee described herein), embodiments of the subject matter described in this specification may be implemented on a computer having a display unit, such as a CRT (cathode ray tube) or LCD (liquid crystal display) monitor, a TFT display, or an OLED display, for displaying information to the user and a keyboard and a pointing device, such as a mouse or a trackball, by which the user may provide input to the computer. Other kinds of devices may be used to provide for interaction with a user as well; for example, feedback provided to the user may be any form of sensory feedback, such as visual feedback, auditory feedback, or tactile feedback; and input from the user may be received in any form, including acoustic, speech, or tactile input. In addition, a computer may interact with a user by sending documents to and receiving documents from a device that is used by the user; for example, by sending web pages to a web browser on a user's device in response to requests received from the web browser.

Implementations of the subject matter described in this specification may be implemented in a computing system that includes a back-end component, such as a data server, or that includes a middleware component, such as an application server, or that includes a front-end component, such as a computer having a graphical user interface or a Web browser through which a user may interact with an implementation of the subject matter described in this specification, or any combination of one or more such back-end, middleware, or front-end components. The components of the system may be interconnected by any form or medium of digital data communication, such as a communication network. Examples of communication networks include a local area network (LAN) and a wide area network (WAN), such as the Internet.

The computing system may include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, may be received from the user device at the server.

While this specification includes many specifics, these should not be construed as limitations on the scope of the invention or of what may be claimed, but rather as descriptions of features specific to particular embodiments of the invention.

Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. The section headings used herein are for organizational purposes only, and are not to be construed as limiting the described subject matter.

What is claimed is:

1. An apparatus, comprising:
a memory storing instructions;
a communications interface; and
at least one processor coupled to the memory and the communications interface, the at least one processor being configured to execute the instructions to:
generate an input dataset based on elements of first interaction data, the elements of first interaction data characterizing an occurrence of a first event during a first temporal interval, and the input dataset comprising at least one element of normalized data;
based on an application of a trained artificial intelligence process to the input dataset, generate output data representative of a predicted likelihood of an occurrence of a second event during a second temporal interval, the second event being associated with the first event, and the second temporal interval being subsequent to the first temporal interval and being separated from the first temporal interval by a corresponding buffer interval; and
transmit at least a portion of the output data to a computing system via the communications interface, the computing system being configured to perform operations consistent with the portion of the output data.

2. The apparatus of claim 1, wherein the at least one processor is further configured to:
receive at least a subset of the elements of first interaction data from the computing system via the communications interface; and
store the subset of the elements of first interaction data within the memory.

3. The apparatus of claim 1, wherein the at least one processor is further configured to:
obtain (i) one or more parameters that characterize the trained artificial intelligence process and (ii) data that characterizes a composition of the input dataset;
generate the input dataset in accordance with the data that characterizes the composition; and
apply the trained artificial intelligence process to the input dataset in accordance with the one or more parameters.

4. The apparatus of claim 3, wherein the at least one processor is further configured to:
based on the data that characterizes the composition, perform operations that at least one of extract a first feature value from the elements of first interaction data or compute a second feature value based on the first feature value; and
generate the input dataset based on at least one of the extracted first feature value or the computed second feature value.

5. The apparatus of claim 1, wherein the output data comprises a numerical value indicative of the predicted likelihood of the occurrence of the second event during the second temporal interval.

6. The apparatus of claim 1, wherein the trained artificial intelligence process comprises a trained, gradient-boosted, decision-tree process.

7. The apparatus of claim 1, wherein the at least one processor is further configured to execute the instructions to:
obtain elements of second interaction data, each of the elements of second interaction data comprising a temporal identifier associated with a temporal interval;
based on the temporal identifiers, determine that a first subset of the elements of second interaction data are associated with a prior training interval, and that a second subset of the elements of second interaction data are associated with a prior validation interval; and
generate training datasets based corresponding portions of the first subset, and perform operations that train the artificial intelligence process based on the training datasets.

8. The apparatus of claim 7, wherein the at least one processor is further configured to execute the instructions to:
generate validation datasets based on portions of the second subset;
apply the trained artificial intelligence process to the plurality of validation datasets, and generate additional elements of output data based on the application of the trained artificial intelligence process to the plurality of validation datasets;
compute one or more validation metrics based on the additional elements of output data; and
based on a determined consistency between the one or more validation metrics and a threshold condition, validate the trained artificial intelligence process.

9. The apparatus of claim 1, wherein:
a pendency period associated with the first event fails to exceed a first threshold duration during the first temporal interval; and
the second event occurs when the pendency period of the first event exceeds a second threshold duration during the second temporal interval.

10. The apparatus of claim 9, wherein:
the first event comprises a delinquency event involving a product, and the second event comprises a default event involving the product;
the first threshold duration comprises thirty days, and the second threshold duration comprises sixty days; and
the second temporal interval comprises eight months, and the buffer interval comprises one month.

11. The apparatus of claim 1, the computing system is further configured to:
identify the operations based on the portion of the output data and on additional data that characterizes the occurrence of the first event, the operations being associated with a reduction in the predicted likelihood of the occurrence of the second event during the second temporal interval;
generate elements of second interaction data that characterize the operations; and
transmit at least a subset of the elements of second interaction data to an additional computing system, the additional computing system being configured to perform at least one of the operations based on the subset of the elements of second interaction data.

12. The apparatus of claim 1, wherein:
the occurrence of the first event is associated with a customer, the customer being associated with an industry identifier;
the first interaction data comprises a first value of a parameter that characterizes the customer; and
the at least one processor is further configured to execute the instructions to:
obtain second interaction data associated with additional customers, each of the additional customers being associated with the industry identifier, and the second interaction data comprising second values of the parameter that characterize the additional customers;
determine an aggregate value of the parameter based on the second values; and
generate the element of normalized data based on the first value of the parameter and on the aggregate value of the parameter.

13. A computer-implemented method, comprising:
generating, using at least one processor, an input dataset based on elements of first interaction data, the elements of first interaction data characterizing an occurrence of a first event during a first temporal interval, and the input dataset comprising at least one element of normalized data;
based on an application of a trained artificial intelligence process to the input dataset, generating, using the at least one processor, output data representative of a predicted likelihood of an occurrence of a second event during a second temporal interval, the second event being associated with the first event, and the second temporal interval being subsequent to the first temporal interval and being separated from the first temporal interval by a corresponding buffer interval; and
transmitting at least a portion of the output data to a computing system using the at least one processor, the computing system being configured to perform operations consistent with the portion of the output data.

14. The computer-implemented method of claim 13, wherein:
the computer-implemented method further comprises:
using the at least one processor, obtaining (i) a value of one or more parameters that characterize the trained artificial intelligence process and (ii) data that characterizes a composition of the input dataset;
based on the data that characterizes the composition, performing operations, using the at least one processor, that at least one of extract a first feature value from the elements of first interaction data or compute a second feature value based on the first feature value;
generating the input dataset comprises generating the input dataset based on at least one of the extracted first feature value or the computed second feature value; and
the computer-implemented method further comprises applying, using the at least one processor, the trained artificial intelligence process to the input dataset in accordance with the one or more parameter values.

15. The computer-implemented method of claim 13, wherein:
the output data comprises a numerical value indicative of the predicted likelihood of the occurrence of the second event during the second temporal interval; and
the trained artificial intelligence process comprises a trained, gradient-boosted, decision-tree process.

16. The computer-implemented method of claim 13, further comprising:
obtaining, using the at least one processor, elements of second interaction data, each of the elements of second interaction data comprising a temporal identifier associated with a temporal interval;
based on the temporal identifiers, determining, using the at least one processor, that a first subset of the elements of second interaction data are associated with a prior training interval, and that a second subset of the elements of second interaction data are associated with a prior validation interval; and
using the at least one processor, generating training datasets based corresponding portions of the first subset, and performing operations that train the artificial intelligence process based on the training datasets.

17. The computer-implemented method of claim 16, further comprising:
generating, using the at least one processor, validation datasets based on portions of the second subset;
using the at least one processor, applying the trained artificial intelligence process to the plurality of validation datasets, and generating additional elements of output data based on the application of the trained artificial intelligence process to the plurality of validation datasets;
computing, using the at least one processor, one or more validation metrics based on the additional elements of output data; and
based on a determined consistency between the one or more validation metrics and a threshold condition, validate the trained artificial intelligence process using the at least one processor.

18. The computer-implemented method of claim 13, the computing system is further configured to:
identify the operations based on the portion of the output data and on additional data that characterizes the occurrence of the first event, the operations being associated with a reduction in the predicted likelihood of the occurrence of the second event during the second temporal interval;
generate elements of second interaction data that characterize the operations; and
transmit at least a subset of the elements of second interaction data to an additional computing system, the additional computing system being configured to perform at least one of the operations based on the subset of the elements of second interaction data.

19. The computer-implemented method of claim 13, wherein:
the occurrence of the first event is associated with a customer, the customer being associated with an industry identifier;
the first interaction data comprises a first value of a parameter that characterizes the customer; and
the computer-implemented method further comprises:
obtaining second interaction data associated with additional customers using the at least one processor, each of the additional customers being associated with the industry identifier, and the second interaction data comprising second values of the parameter that characterize the additional customers;
determining, using the at least one processor, an aggregate value of the parameter based on the second values; and
generating, using the at least one processor, the element of normalized data based on the first value of the parameter and on the aggregate value of the parameter.

20. A tangible, non-transitory computer-readable medium storing instructions that, when executed by at least one processor, cause the at least one processor to perform a method, comprising:
generating an input dataset based on elements of first interaction data, the elements of first interaction data characterizing an occurrence of a first event during a first temporal interval, and the input dataset comprising at least one element of normalized data;
based on an application of a trained artificial intelligence process to the input dataset, generating output data representative of a predicted likelihood of an occurrence of a second event during a second temporal interval, the second event being associated with the first event, and the second temporal interval being subsequent to the first temporal interval and being separated from the first temporal interval by a corresponding buffer interval; and
transmit at least a portion of the output data to a computing system, the computing system being configured to perform operations consistent with the portion of the output data.
